(19) United States
(12) Patent Application Publication
(10) Pub. No.: US 2025/0134756 A1
(43) Pub. Date: May 1, 2025

(54) MYOFASCIAL DEVICE WITH ROTATABLE ASSEMBLY

(71) Applicant: Plexus Yoga, LLC, Lehi, UT (US)

(72) Inventors: Tate Sherman Stock, Draper, UT (US); Reeve Stewart Sudweeks, Lehi, UT (US); Jason Lee Walton, Draper, UT (US); Weston N. Hills, Kamas, UT (US); Brian Connolly Nielson, American Fork, UT (US)

(21) Appl. No.: 18/925,408

(22) Filed: Oct. 24, 2024

Related U.S. Application Data
(60) Provisional application No. 63/546,100, filed on Oct. 27, 2023.

(51) Int. Cl. A61H 15/00; A61H 39/04

(52) U.S. Cl. CPC A61H 15/0085; A61H 39/04; A61H 2015/0014; A61H 2201/1215; A61H 2201/5025; A61H 2201/5043

(57) ABSTRACT

A myofascial device includes a handle having a first end and a second end, a motor at least partially disposed within the handle, a battery at least partially disposed within the handle, and a rotatable assembly disposed between the first end and the second end. The rotatable assembly is configured to rotate during operation of the motor. The rotatable assembly includes a first frame, a second frame, shafts disposed between the first frame and the second frame, first rotatable elements disposed about a first portion of the shafts, and second rotatable elements disposed about a second portion of the shafts.

### CROSS-REFERENCE TO RELATED APPLICATIONS

This application claims priority to U.S. Provisional Patent Application No. 63/546,100, filed Oct. 27, 2023, entitled “Myofascial Device with Rotatable Assembly,” the entirety of which is herein incorporated by reference.

### BACKGROUND

Musculoskeletal evaluation and treatment applications have been used extensively in pain relief, massage therapy, and chiropractic clinics. Different methods of application and therapy tools have been proposed in an effort to find effective solutions that both clinicians and patients can use to treat some of the most common and widespread causes of muscular and myofascial pain and dysfunction. However, some of these therapy tools are difficult to use and/or may provide ineffective treatments against muscular and myofascial pain and dysfunction.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The components, devices, and/or apparatuses depicted in the accompanying figures are not to scale and components within the figures may be depicted not to scale with each other.

FIG. 1 illustrates a perspective view of an example device that provides myofascial treatment, according to an embodiment of the present disclosure.

FIG. 2A illustrates a first side view of the device of FIG. 1, according to an embodiment of the present disclosure.

FIG. 2B illustrates a second side view of the device of FIG. 1, according to an embodiment of the present disclosure.

FIG. 2C illustrates a third side view of the device of FIG. 1, according to an embodiment of the present disclosure.

FIG. 2D illustrates a fourth side view of the device of FIG. 1, according to an embodiment of the present disclosure.

FIG. 3A illustrates a first view of an internal compartment of the device of FIG. 1, showing example components disposed within the internal compartment, according to an embodiment of the present disclosure.

FIG. 3B illustrates a second view of the internal compartment of FIG. 3A, according to an embodiment of the present disclosure.

FIG. 4A illustrates an example motor disposed within the internal compartment of FIG. 3A, according to an embodiment of the present disclosure.

FIG. 4B illustrates an example gear of the motor of FIG. 4A, according to an embodiment of the present disclosure.

FIG. 5A illustrates a perspective view of an example housing of the device of FIG. 1, according to an embodiment of the present disclosure.

FIG. 5B illustrates a planar view of the housing of FIG. 5A, according to an embodiment of the present disclosure.

FIG. 6 illustrates a perspective view of an example rotatable assembly, an example axle, and an example gear of the device of FIG. 1, according to an embodiment of the present disclosure.

FIG. 7A illustrates a perspective view of the rotatable assembly of FIG. 6, according to an embodiment of the present disclosure.

FIG. 7B illustrates an end view of the rotatable assembly of FIG. 6, according to an embodiment of the present disclosure.

FIG. 7C illustrates a cross-sectional view of the rotatable assembly of FIG. 6, taken along line A-A of FIG. 7B, according to an embodiment of the present disclosure.

FIG. 8 illustrates a partial view of the rotatable assembly of FIG. 6, showing example frames, example bushings, and example shafts, according to an embodiment of the present disclosure.

FIG. 9 illustrates a partial view of the rotatable assembly of FIG. 6, showing the frames and the shafts of FIG. 8, according to an embodiment of the present disclosure.

FIG. 10 illustrates a partially exploded view of the rotatable assembly of FIG. 6, showing the frames and the shafts of FIG. 8, according to an embodiment of the present disclosure.

FIG. 11A illustrates a perspective view of an example first frame of the rotatable assembly of FIG. 6, according to an embodiment of the present disclosure.

FIG. 11B illustrates a planar view of the first frame of FIG. 11A, according to an embodiment of the present disclosure.

FIG. 12A illustrates a perspective view of an example second frame of the rotatable assembly of FIG. 6, according to an embodiment of the present disclosure.

FIG. 12B illustrates a planar view of the second frame of FIG. 12A, according to an embodiment of the present disclosure.

FIG. 13A illustrates a first end of the rotatable assembly of FIG. 6 at least partially disposed within housing(s) of the device of FIG. 1, according to an embodiment of the present disclosure.

FIG. 13B illustrates a second end of the rotatable assembly of FIG. 6 at least partially disposed within housing(s) of the device of FIG. 1, according to an embodiment of the present disclosure.

FIG. 14A illustrates a side view of an example first rotatable element of the rotatable assembly of FIG. 6, according to an embodiment of the present disclosure.

FIG. 14B illustrates a cross-sectional view of the first rotatable element of FIG. 14A, taken along line B-B of FIG. 14A, according to an embodiment of the present disclosure.

FIG. 15A illustrates a side view of an example second rotatable element of the rotatable assembly of FIG. 6, according to an embodiment of the present disclosure.

FIG. 15B illustrates a cross-sectional view of the second rotatable element of FIG. 15A, taken along line C-C of FIG. 15A, according to an embodiment of the present disclosure.

### DETAILED DESCRIPTION

This application is directed, at least in part, to a device having rotatable elements that treat muscular pain, myofascial pain, trigger points, and the like. In an embodiment, the device may include a handle to be gripped or otherwise held by a user. A rotatable assembly rotatably couples to the handle and includes the rotatable elements. The rotatable assembly may additionally include one or more frames having shafts about which the rotatable elements are disposed, respectively. Additionally, the device includes one or more motors that, when actuated, cause the rotatable assembly to rotate. In an embodiment, the device may be used freehandedly such that the user may maneuver the device to/over portions of their body (e.g., legs, back, arms, etc.) to provide or treat muscular pain, myofascial pain, trigger points, and the like.

In an embodiment, the handle may be formed at least in part by a first housing and a second housing that couple together. For example, the first housing and the second housing may be coupled together via fasteners, snap-fits, adhesives, and/or any combination thereof. In an embodiment, the first housing and/or the second housing may include alignment mechanisms that align the first housing and the second housing together. For example, pins, tabs, flanges, keys, keyways, etc., of the first housing and the second housing may engage with one another to align the first housing and the second housing. The first housing and the second housing may define cavities, voids, compartments, pockets, etc., in which components of the device are disposed. For example, one or more motor(s), batteries, printed circuit board(s) (PCBs), sensor(s), etc., may be disposed within the first housing and/or the second housing. Although described as including two housings, the device may include more than or less than two housings.

In an embodiment, the handle may have a trapezoidal shape, semi-circular shape, ovular shape, etc., capable of being grasped at different positions (e.g., along different sides). However, other cross-sectional shapes and/or shapes of the handle are envisioned. Portions of the handle may also include grips (e.g., rubber, foam, silicon, etc.), different surface finishes or textures, different materials, and the like to permit the user to grasp the handle and/or to increase a comfort of the user when grasping the handle. Alternatively, the housings may include different surface finishes, textures, etc., to assist the user in grasping the device.

In an embodiment, the rotatable assembly may be disposed between ends of the handle. For example, the handle may include a first end and a second end, and the rotatable assembly may be disposed between the first end and the second end. A gap distance may span between the first end and the second end, whereby the rotatable assembly may be disposed within the gap distance. Between the first end and the second end, the handle may include, follow, or be disposed along a path corresponding to a trapezoidal shape. The rotatable assembly may be mounted about an axle coupled or secured to the handle. For example, the first housing and the second housing may include features, such as receptacles, slots, etc., in which ends of the axle are disposed. The rotatable assembly may therefore couple to the handle at two locations, and the axle may extend between the first end and the second end of the handle. In other words, the axle may span between the ends of the handle. Bearings may also be used to couple the axle to the handle.

The handle may define an interior cavity to permit a user to grasp the handle without their hands contacting the rotatable assembly. The interior cavity may be disposed between sides and/or surfaces of the handle. When the rotatable assembly couples to the handle, the interior cavity may be defined between a portion of the handle and the rotatable assembly (e.g., a periphery of the rotatable assembly). The interior cavity may provide a space (e.g., area, volume, etc.) for the user to wrap their hand(s) around the handle without contacting the rotatable assembly.

In an embodiment, the rotatable assembly may include a first frame (e.g., section, segment, portion, half, etc.) and a second frame (e.g., segment, portion, half, etc.). Shafts may be disposed between the first frame and the second frame. In an embodiment, the shafts are coupled to the first frame and/or the second frame via fasteners. Additionally, or alternatively, the first frame and the second frame may be coupled together via fasteners to secure the shafts between the first frame and the second frame. In an embodiment, the shafts may be disposed within receptacles of the first frame and the second frame, respectively. For example, a first end of the shafts may be disposed within receptacles of the first frame, and a second end of the shafts may be disposed within receptacles of the second frame. The rotatable elements may be disposed about the shafts, respectively. In an embodiment, the rotatable assembly may include any number of shafts having the rotatable elements. In an embodiment, the first frame and the second frame may include prongs, slots, receptacles, etc., that engage to align the first frame and the second frame.

In an embodiment, the rotatable elements may include a plurality of first rotatable elements and a plurality of second rotatable elements. The first rotatable elements may include first structural features (e.g., ribs, protrusions, texture, etc.) and the second rotatable elements may include second structural features (e.g., ribs, protrusions, texture, etc.) that are different than the first structural features. In an embodiment, the first structural features and the second structural features may be complimentary in that the first structural features and the second structural features are interlocking, interwoven, etc. For example, each of the first rotatable elements and the second rotatable elements may have a first end and a second end spaced apart from the first end. Between the first end and the second end, the exterior surface of the first rotatable elements and the second rotatable elements may undulate to form peaks and valleys. Peaks of the exterior surface of the first rotatable elements may be disposed within valleys of the exterior surface of the second rotatable elements. Likewise, peaks of the exterior surface of the second rotatable elements may be disposed within valleys of the exterior surface of the first rotatable elements.

The undulating surface of the first rotatable elements and the second rotatable elements may be offset from one another when coupled to the first frame and the second frame such that the peaks of the exterior surface formed in the first rotatable element fits, resides, is disposed within, or is received by, the valleys formed in the exterior surface of the second rotatable element. This may prevent portions of the user, clothing of the user, or items becoming pinched or drawn in to the rotating rotatable elements. Moreover, in an embodiment, a cover (e.g., fabric, cloth, neoprene cover) may be disposed over the rotatable elements (e.g., around a portion of the rotatable assembly). In an embodiment, the cover may rotate during rotation of the rotatable assembly, or may remain stationary during rotation of the rotatable assembly (e.g., via coupling to the handle).

Although the first rotatable elements and the second rotatable elements are described as having undulating surfaces, in an embodiment, the first rotatable elements and the second rotatable elements may include other surfaces and/or be differently shaped. For example, the first rotatable elements and the second rotatable elements may include different surface finishes, shapes, contours, etc. to provide or treat muscular pain, myofascial pain, trigger points, and the like.

The first rotatable elements and the second rotatable elements may also be manufactured from different materials, materials with different durometers, etc., Moreover, in an embodiment, the first rotatable elements and the second rotatable elements may be made up of a single piece of material, or may include multiple pieces of materials. The rotatable elements may be manufactured from a low-density foam or rubber material, though other compressible materials may be used as well. In an embodiment, the rotatable elements may include a closed-cell foam such as an ethylene-vinyl acetate (“EVA”) foam. In an embodiment, the rotatable elements may have durometer rating of between approximately forty and approximately sixty.

Additionally, although the first rotatable elements and the second rotatable elements are described as having an exterior surface with certain features, the first rotatable elements and the second rotatable elements may include exterior surfaces with different features that are complimentary, non-complimentary, similar, different, etc. Moreover, in an embodiment, the rotatable assembly may be interchangeable with other rotatable assemblies. For example, each rotatable assembly may have rotatable elements with a certain contour or shape, and interchanging the rotatable assemblies may provide for rotatable elements with different contours and shapes. Additionally, or alternatively, instead of replacing the rotatable assembly, the rotatable elements may be interchangeable with one another.

In an embodiment, the rotatable elements may rotate independently of the rotatable assembly. For example, while the rotatable elements may be disposed about the shafts, the rotatable elements may not be rigidly coupled to the shafts and/or the shafts may not be rigidly coupled to the first frame and/or the second frame. Instead, as noted above, the shafts may be disposed within the receptacles of the first frame and the second frame, and permitted to rotate within the receptacles of the first frame and the second frame. In such instances, the rotatable elements may independently rotate about their own respective axis disposed through the shafts about which the rotatable elements are respectively disposed.

The rotatable assembly may be disposed about the axle that extends between the first end of the handle and the second end of the handle. The rotatable assembly, such as the first frame and/or the second frame, may couple to the axle. In an embodiment, the first frame and the second frame may form a channel through which the axle is disposed. During rotation of the axle, the rotatable assembly may correspondingly rotate. In an embodiment, portions of the first frame and/or the second frame may be disposed at least partially within the handle. For example, the handle (or the first housing and the second housing) may define pockets in which ends of the first frame and the second frame are at least partially disposed. Portions of the handle may therefore extend over, or at least partially encapsulate, part of the first frame and the second frame. This may prevent portions of the user (e.g., fingers, skin, etc.), clothing of the user, or items becoming pinched or drawn in during rotation of the rotatable assembly.

In an embodiment, the rotatable assembly may include one or more gears that engage with one or more gear(s) of the motor (or which are operably coupled to the motor). For example, a first gear of the motor may engage with a second gear of the rotatable assembly. In an embodiment, the second gear may be formed on, within, etc. the axle, or may be coupled to the axle. Alternatively, in an embodiment, more than one motor may be included such that the rotatable assembly may be rotated from both ends (e.g., from both ends of the axle). In such instances, the rotatable assembly may include more than one motor and/or respective gears. During actuation of the motor, the first gear rotates, and via an engagement with the second gear, rotational movement is imparted to the rotatable assembly. In an embodiment, the first gear represents a worm gear and the second gear represents a worm wheel or a helical gear. However, other gears (e.g., helical, spur, etc.) may be used. In an embodiment, the motor is mounted within the handle and rotates the first gear about a first axis. In an embodiment, the rotatable assembly may be rotated from one end. The second gear, as well as the axle, may rotate about a second axis that is orthogonal to the first axis. However, the first gear may rotate about other axes that are parallel or non-parallel to the second axis.

The device may include one or more input components, such as buttons, levers, toggles, switches, etc., that at least partially control an operation of the device. In an embodiment, the one or more input components may power on and power off the device, control a speed of the motor(s), and so forth. For example, depending upon the desired relief, the motor(s) may operate at different speeds to rotate the rotatable assembly. In an embodiment, the buttons, levers, switches, etc. may receive different types of inputs to change the speed of the motor(s). For example, pressing and holding the button for a first period of time (e.g., one second) may cause the motor to operate at a first speed, pressing and holding the button for a second period of time, (e.g., two seconds) may cause the motor(s) to operate at a second speed that is different than the first speed, and so forth. In an embodiment, the motor(s) may be configured to operate at any number of speeds (e.g., one, two, four, five, ten, etc.). Alternatively, rather than providing different inputs for different periods of time, the button may be depressed a certain number of times for powering on and/or changing or setting the speed. For example, pressing the button once may power on the device, pressing the button twice (or once after the device is powered on) may cause the motor(s) to operate at the first speed, pressing the button three times (or once after the motor(s) operate at the first speed) may cause the motor to operate at the second speed, and so forth.

The one or more input components may additionally or alternatively control heat, vibration, time of operation, etc. The device may also include safety switches, toggles, deadman switch, etc., that permit operation of the device. For example, in order to control the speed of the motor, a first button may be depressed, and while depressing the first button, a second button may be used to control the speed of the motor. This may, for example, prevent an inadvertent operation of the device. However, once the speed of the motor is set, the first button and/or the second button may be released such that the user may not have to continuously depress the first button and/or the second button.

In an embodiment, sensor(s) may be disposed within the handle for detecting a presence of the user grasping the handle. For example, capacitive-type sensor(s), proximity sensor(s), resistive-type sensor(s), optical sensor(s), etc., may be disposed within the handle. The sensor(s) may generate sensor data indicative of whether the user is gripping the handle. If the sensor data indicates a presence of the user grasping the handle, the motor may be permitted to actuate. Comparatively, if the sensor data indicates a lack of presence of the user grasping the handle, the motor may be restricted from actuating. For example, while operating the device, if the user releases the handle, the motor(s) may be deactivated if the presence of the user is not sensed, or is not sensed for a threshold period of time. This may, for example, increase a safety of the device and permit unintended operation of the device. Any number of sensor(s) may be disposed about the handle.

The device may, in an embodiment, include one or more output components such as lighting element(s), speaker(s), etc. The lighting elements may output an indication of the speed of the motor and/or other settings of the device. For example, if the motor includes three speeds, and the user has selected the second speed, the lighting element(s) may output an indication of such. In an embodiment, the device may include a light bar, a light ring, a series of lights, etc. that is/are illuminated to indicate the speed of the motor. In other embodiments, the speakers may output an indication of the speed (e.g., low, medium, high, etc.). Of course, it is to be understood that the output components may output other indications associated with additional or alternative setting(s) of the device. For example, the speaker(s) may output audible indications associated with an operation of the device (e.g., “Power on”, “Power off”, “Speed 1”, etc.).

In an embodiment, the device may be configured to continuously adapt based on sensed conditions. For example, a sensor may measure the current (e.g., draw) on the motor during use. If a user, for example, changes an amount of force by which the device is pressed against their body (e.g., legs, arms, etc.), and therefore, a speed of the rotatable assembly (or the motor) is reduced, the device may sense this reduction. If the draw on the motor is greater than a threshold for a threshold period of time, the device may cause an increased current to be supplied to the motor to increase its speed. In doing so, the user may be capable of applying the device to their body at a given force without sacrificing the speed at which the rotatable assembly rotates. Upon removal of the device, less resistance is provided to the motor and consequently, the motor may rotate at higher speeds. However, if the draw on the motor is less than the threshold for the threshold period of time, the device may cause a decreased current to be supplied to the motor to decrease its speed.

In addition to the components of the device described above, the device may include various components that permit its operation. For example, the device may include various hardware components (e.g., processor(s), memory, PCBs, printed circuit board assemblies (PCBAs), etc.), sensor(s) (e.g., temperature, force, pressure, resistance, etc.), batteries, ports (e.g., charging, auxiliary, USB-C), network interfaces (e.g., Wi-Fi, Bluetooth, Cellular, etc.) to permit connection with one or more devices (e.g., phone, tablet, computer, etc.), heat dissipating elements, and so forth. The components may be disposed within handle and communicatively coupled to one another via wires, cables, etc.

Suitable manufacturing techniques for forming the device include injection molding, extrusion, casting, etc. The device, or components thereof, may also be made from metal (e.g., aluminum), plastic, composites, and/or any combination thereof.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

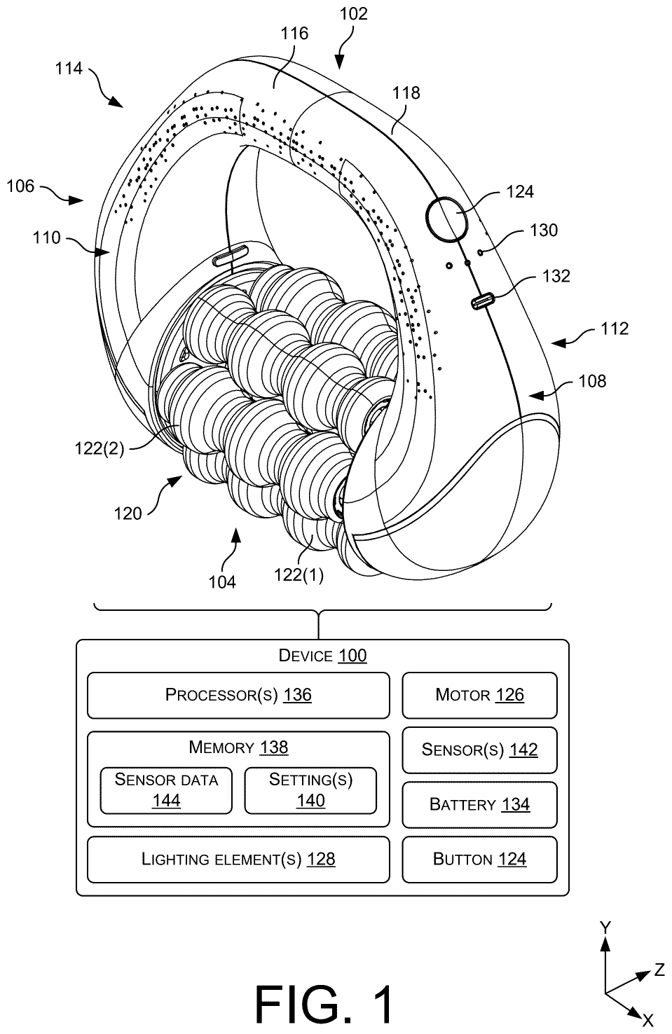

FIG. 1 illustrates an example device 100, according to an embodiment of the present disclosure. In an embodiment, the device 100 may include a first side 102 (e.g., top), a second side 104 (e.g., bottom) spaced apart from the first side 102 (e.g., in the Y-direction), a third side 106 (e.g., left-hand side), a fourth side 108 (e.g., right-hand side) spaced apart from the third side 106 (e.g., in the X-direction), a fifth side 110 (e.g., front), and a sixth side 112 (e.g., back) spaced apart from the fifth side 110 (e.g., in the Z-direction).

The device 100, in an embodiment, may include a handle 114 to be held by a user operating the device 100. For example, a hand of the user may grip, wrap around, etc., the handle 114. The handle 114 may extend along the first side 102, the third side 106, the fourth side 108, and at least partially along the second side 104. The handle 114 may also extend along the fifth side 110 and the sixth side 112.

In an embodiment, the handle 114 may be formed via one or more housings. For example, the handle 114 may be formed at least in part by a first housing 116 and a second housing 118. The first housing 116 may be disposed along the fifth side 110, and the second housing 118 may be disposed along the sixth side 112. In an embodiment, the first housing 116 and the second housing 118 may be coupled together via snap-fits, press-fits, fasteners, adhesives, etc. In an embodiment, covers, shrouds, etc., may be disposed over fasteners that couple the first housing 116 and the second housing together to provide the device 100 with a clean aesthetic experience.

The device 100 includes a rotatable assembly 120 that is disposed between ends of the handle 114. As will be explained herein, the rotatable assembly 120 may rotatably couple to the handle 114, between ends of the handle 114. In other words, the handle 114 may not extend completely along the second side 104 in order to provide a space for the rotatable assembly 120. During operation, the rotatable assembly 120 may rotate about an axis (e.g., about the X-axis) extending centrally through the rotatable assembly 120. The rotatable assembly 120 rotates between the ends of the handle 114, independent of the handle 114. During rotation of the rotatable assembly 120 the handle 114 may remain stationary.

The rotatable assembly 120 may include a plurality of rotatable elements 122, such as first rotatable elements 122(1) and second rotatable elements 122(2). The first rotatable elements 122(1) and the second rotatable elements 122(2) may be alternatingly coupled to or disposed on/about the rotatable assembly 120 (e.g., about the X-axis). For example, the first rotatable elements 122(1) and the second rotatable elements 122(2) may alternate with one another around the rotatable assembly 120. As will also be explained herein, the first rotatable elements 122(1) and the second rotatable elements 122(2) may include different surfaces, curves, textures, etc., that are complimentary so as to interweave, interlock, intertwine, etc., with one another. In an embodiment, an exterior surface of the first rotatable elements 122(1) and the second rotatable elements 122(2) undulate along at least a portion of the length of the first rotatable elements 122(1) and the second rotatable elements 122(2), respectively (e.g., in the X-direction). For example, the first rotatable elements 122(1) and the second rotatable elements 122(2) may have an undulating exterior surface.

In an embodiment, the rotatable assembly 120 may be interchangeable with other rotatable assemblies. For example, each of the rotatable assemblies may have rotatable elements with different contours, shapes, number, etc. Interchanging the rotatable assembly 120 may provide different forms of therapeutic relief. Alternatively, in an embodiment, rather than the rotatable assembly 120 being interchangeable, the rotatable elements 122 may be interchangeable. Regardless, in an embodiment, quick-disconnect features (e.g., latches, levers, etc.) may be used to interchange the rotatable assembly 120 and/or the rotatable elements 122 with one another.

In an embodiment, the device 100 includes a button 124 (e.g., toggle, switch, etc.) that at least partially controls an operation of the device 100. For example, as will be explained herein, a motor 126 may be disposed within the handle 114, such as an internal compartment, and may operably couple to the rotatable assembly 120 for imparting motion to the rotatable assembly 120. The button 124, for example, may control a speed and/or setting(s) of the motor 126. In an embodiment, the button 124 may be pressed for different periods of time and/or a different number of times for controlling the speed of the motor 126, powering on/off the motor 126, and so forth. As examples, pressing and holding the button 124 for a first period of time (e.g., one second) may cause the motor 126 to operate at a first speed, pressing and holding the button 124 for a second period of time, (e.g., two seconds) may cause the motor 126 to operate at a second speed that is different than the first speed, and so forth. Additionally or alternatively, rather than providing different inputs for different periods of time, the button 124 may be depressed a certain number of times for changing or setting the speed of the motor 126. For example, pressing the button 124 once may cause the motor 126 to operate at the first speed, pressing the button 124 twice (e.g., consecutively) may cause the motor 126 to operate at the second speed, and so forth. In an embodiment, the motor 126 may be configured to operate at any number of speeds (e.g., one, two, four, five, ten, etc.).

In an embodiment, the button 124 may be located on the handle 114, along the fourth side 108 and/or proximate to the first side 102. However, the button 124 may be located elsewhere on the handle 114. Moreover, the device 100 may include more than one button 124. In an embodiment, the button 124 represents a mechanical type of button, a resistive type of button, a capacitive type of button, and so forth. Additionally, although described as a button, the button 124 may represent a switch, lever, knob, etc., that may be depressible, rotatable, or otherwise actuatable. The device 100 may also include buttons (e.g., shape, size, etc.) other than shown.

The device 100 may include lighting element(s) 128 that output light through apertures 130 disposed in the handle 114 (or which are defined by the first housing 116 and/or the second housing 118). In an embodiment, the lighting element(s) 128 may output an indication associated with the speed of the motor 126 and/or other setting(s) 140 of the device 100, via the apertures 130. For example, introduced above, the motor 126 may include different speeds. In an embodiment, the motor 126 may include three speeds (e.g., low, medium, high) and if the user has selected a second speed, the lighting element(s) 128 may output light through a second aperture of the apertures 130. If the user has selected a third speed, the lighting element(s) 128 may output light through a third aperture of the apertures 130. As such, the apertures 130 may be used to indicate an operational state or status of the device 100.

In an embodiment, the apertures 130 may be disposed along an arc. Although three of the apertures 130 are shown and described, the device 100 may include more than or less than three of the apertures 130. Additionally, the apertures 130 may be located differently on or about the device 100 than shown. Still, rather than having the apertures 130, the device 100 may include a light bar, display screen, or other components to indicate the speed of the motor 126, or more generally, the setting(s) 140 of the device 100.

The handle 114 may include a port 132 into which a cord, cable, wire, etc., is insertable. In an embodiment, the port 132 may correspond to a charging port into which a power cable is disposed for charging a battery 134 of the device 100. The port 132 may represent any type of port, such as an auxiliary port, a USB-C port, etc. Additionally, or alternatively, instead of being used to charge the battery 134, the port 132 may be used to provide updates to the device 100, upload/download data, etc. As shown, the port 132 may be located along the fourth side 108, however, the port 132 may be located differently than shown. In an embodiment, the apertures 130 may be disposed between (e.g., interposed between) the button 124 and the port 132.

The device 100 is shown including processor(s) 136 and memory 138, where the processor(s) 136 may cause the device 100 to perform various functions and operations associated with providing or treating muscular pain, myofascial pain, trigger points, and the like, and the memory 138 may store instructions executable by the processor(s) 136 to perform the operations described herein. The device 100 may operate according to the setting(s) 140. In an embodiment, the setting(s) 140 indicate the speed of the motor 126 for rotating the rotatable assembly 120. For example, the setting(s) 140 may indicate revolutions per minute (RPMs) that the motor 126 is to operate. In an embodiment, the motor 126 may have different RPMs according to the speed desired of the user. In an embodiment, the motor 126 may operate at three different speeds, however, the motor 126 may have the ability to operate at less than three or more than three speeds. In an embodiment, the speed of the motor 126 may be received via the button 124 of the device 100. For example, the user may provide input to the button 124 to indicate the desired speed of the motor 126. The user may provide the setting(s) 140 via the button 124 or other input components (e.g., levers, dials, etc.).

The device 100 may include the lighting element(s) 128 that may output an indication of the setting(s) 140 of the device 100, an operational state/status of the device 100, and so forth. For example, the lighting element(s) 128 may output light to indicate whether the device 100 is powered on. The lighting element(s) 128 may output light according to the determining speed of the motor 126. For example, the lighting element(s) 128 may output light to indicate the speed of the motor 126. This may provide visual feedback to the user regarding the selected speed of the motor 126. In an embodiment, the lighting element(s) 128 may output light through a light guide, where each portion (e.g., section, prong, etc.) of the light guide may be capable of being individually illuminated to indicate the speed of the motor 126.

The setting(s) 140 may include other operational characteristics of the device 100 other than the speed of the motor 126. For example, the setting(s) 140 may be associated with a vibrational motor imparting vibration to the device 100, heat being generated by heater(s) of the device 100, a timing of cycle of when the motor 126 turn on/off, change speed, change rotational direction, etc., and so forth. As such, it is to be understood that the user, or rather the device 100, may operate according to the setting(s) 140 to provide or treat muscular pain, myofascial pain, trigger points, and the like.

Although the device 100 is shown including certain components, the device 100 may include additional or alternative components other than those described. For example, the device 100 may include speaker(s) for outputting sound (e.g., sound associated with the setting(s) 140, sound associated with a training/therapy session for the user, etc.), microphone(s) for capturing sound (e.g., user speech, voice commands, etc.), vibrational motors, heaters for generating heat, network interface(s) for communicating with one or more device(s) (e.g., mobile phone), and so forth.

The device 100 further includes the battery 134 for providing the device 100, and components therein, with power. For example, the battery 134 may be coupled to the motor 126. In an embodiment, the motor 126 may represent a brushless DC motor. The battery 134 may also be recharged (e.g., via the port 132) and/or replaceable.

The device 100 may also include sensor(s) 142 that generate sensor data 144. The sensor(s) 142 may include temperature sensor(s), ammeter sensor(s), voltage sensor(s), proximity sensor(s), etc. In an embodiment, the sensor(s) 142 may measure a current (e.g., draw) on the motor 126, where the sensor data 144 indicates the current supplied to the motor 126. The sensor data 144 may be used to dynamically adjust the setting(s) 140 of the device 100, for example, based on the resistance to the motor 126. If the user changes an amount of force by which the device 100 (e.g., the rotatable assembly 120) is pressed against their body (e.g., legs, arms, etc.), the speed of the motor 126 and therefore the rotatable assembly 120, may reduce. The sensor(s) 142 may measure the draw on the motor 126, and if the draw is greater than a certain threshold for a certain period of time, the motor 126 may dynamically increase in speed to account for the increased resistance.

For example, suppose that the user selects the first setting (e.g., speed) of the motor 126. At this setting, the motor 126 may rotate the rotatable assembly 120 at a certain speed. During use, if the user presses the rotatable assembly 120 against their body with a certain amount of force, the rotatable assembly 120 may be rotated at a slower speed than desired (e.g., less than the first setting). That is, the force may provide resistance to the motor 126, and as a result, the rotatable assembly 120 may not rotate according to the desired speed. If the resistance on the motor 126 is greater than a threshold for a threshold period of time, the device 100 may cause an increased current to be supplied to the motor 126 for rotating at the desired speed. In doing so, the user may be capable of applying the device 100 to their body at a given force without sacrificing the speed at which the rotatable assembly 120 rotates. Upon removal of the device 100 from the user, less resistance is provided to the motor 126 and consequently, the motor 126 may rotate the rotatable assembly 120 at a higher speed than desired. However, if the draw on the motor 126 is less than the threshold for the threshold period of time, the device 100 may cause a decreased current to be supplied to the motor 126 to decrease in speed.

In an embodiment, a cover may disposed at least partially over the rotatable assembly 120. In an embodiment, the cover may be secured to the rotatable assembly 120 and rotate with the rotatable assembly 120. Alternatively, the cover may be secured to the handle 114 such that the rotatable assembly 120 rotates within the cover. The rotatable elements 122 may act through the cover to engage the user. In an embodiment, the cover may prevent portions of the user (e.g., fingers, skin, etc.), clothing of the user, or items becoming pinched or drawn in during rotation of the rotatable assembly 120. For example, the cover may prevent pinching between the first rotatable elements 122(1) and the second rotatable elements 122(2). The cover may include a piece of fabric, cloth, plastic, etc. Suitable materials include neoprene, polyester, nylon, etc.

As used herein, a processor, such as the processor(s) 136, may include multiple processors and/or a processor having multiple cores. Further, the processor(s) 136 may comprise one or more cores of different types. For example, the processor(s) 136 may include application processor units, graphic processing units, and so forth. In one implementation, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

Memory, such as the memory 138 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s). The memory 138 are examples of non-transitory computer-readable media. The memory 138 may store an operating system and one or more software applications, instructions, programs, and/or data to implement the methods described herein and the functions attributed to the various systems.

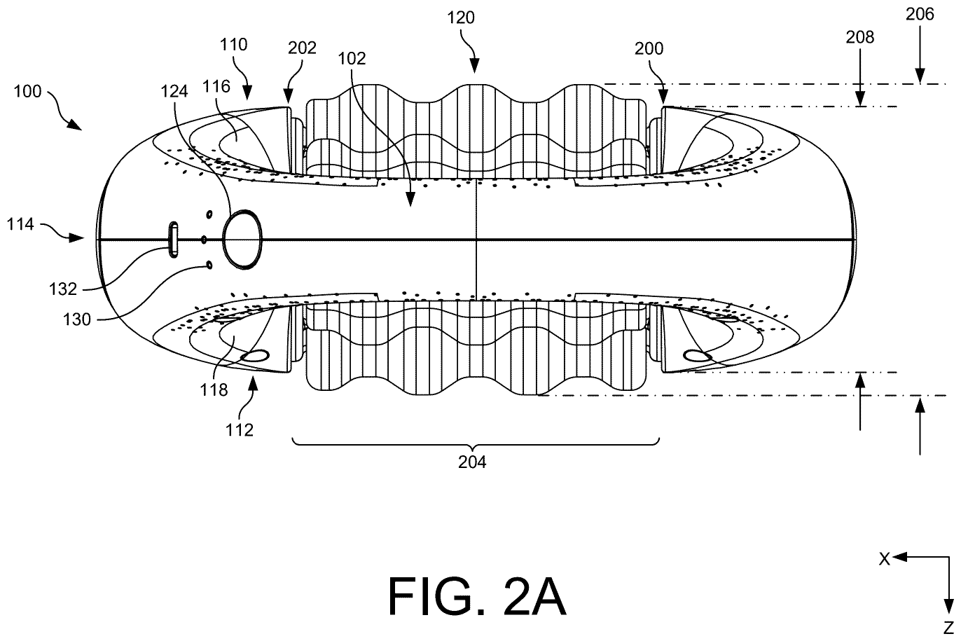

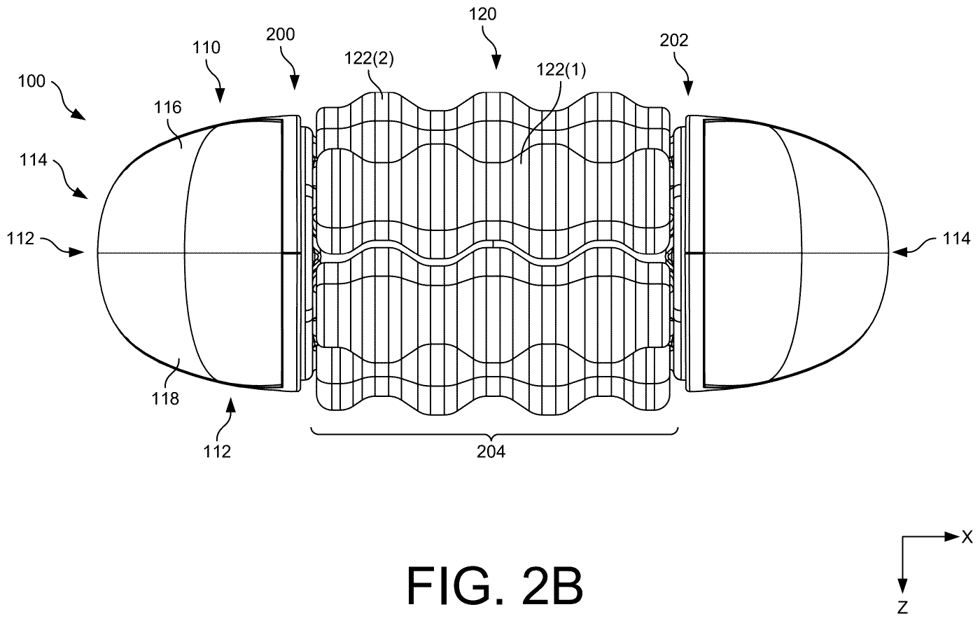

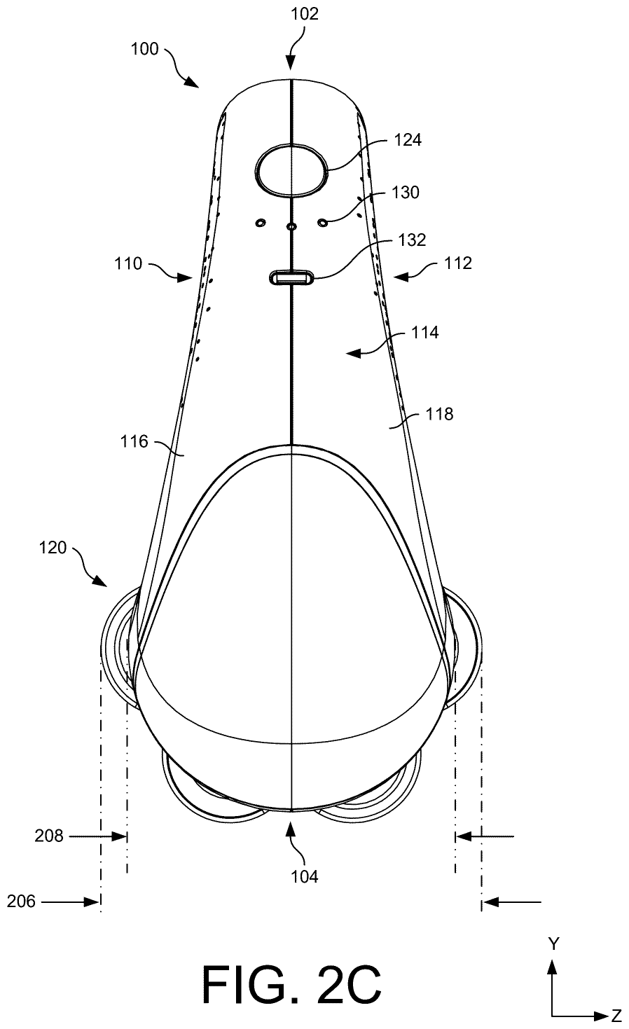

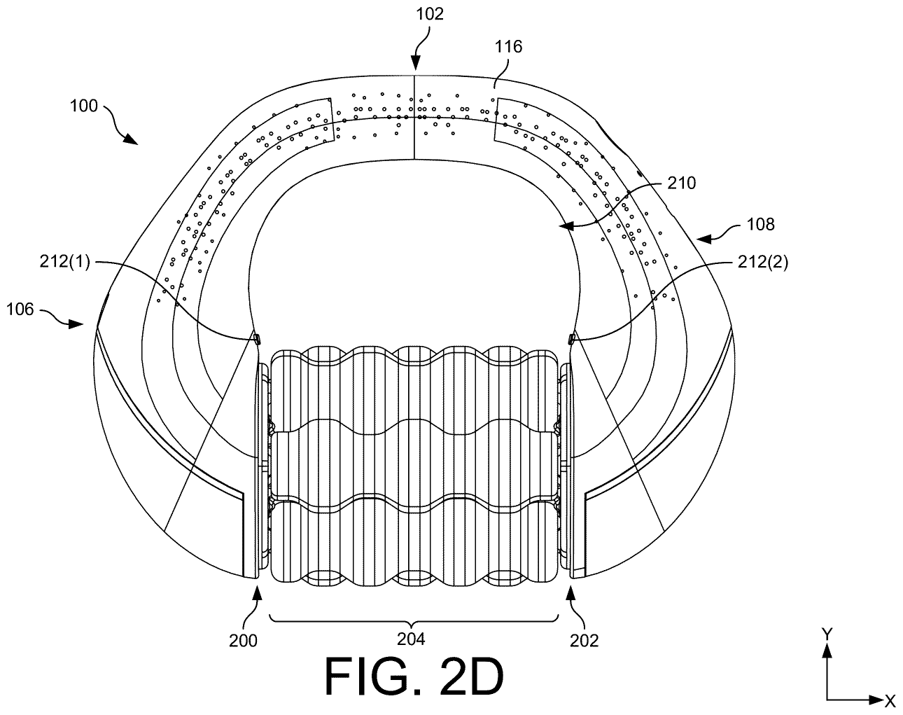

FIGS. 2A-2D illustrate various side views of the device 100, according to examples of the present disclosure. FIG. 2A illustrates the first side 102 of the device 100, FIG. 2B illustrates the second side 104 of the device 100, FIG. 2C illustrates the fourth side 108 of the device 100, and FIG. 2D illustrates the fifth side 110 of the device 100.

The device 100 may include the button 124 for controlling an operation of the device 100. In an embodiment, the button 124 corresponds to an on/off button, a button for controlling a speed of the motor 126, etc. Although described as including a single button, the device 100 may include more than one button. The handle 114, or the first housing 116 and/or the second housing 118, also define the apertures 130 for emitting light via the lighting element(s) 128 disposed within the handle 114. In an embodiment, the apertures 130 are arranged along an arc or curve, or follow a curvature of the button 124. In an embodiment, the apertures 130 are formed by the first housing 116 and/or the second housing 118. In an embodiment, the apertures 130 are centered between the fifth side 110 of the device 100 and the sixth side 112 of the device 100. Although a particular location or disposition of the apertures 130 are shown, other locations, dispositions, orientation, etc. are envisioned. The port 132 is further included for charging the battery 134 of the device 100, uploading/downloading data, etc.

In an embodiment, the apertures 130 may be disposed between (e.g., in the Y-direction) the button 124 and the port 132. The button 124 may be located more proximate to the first side 102 as compared to the apertures 130 and the port 132. The apertures 130 may be located more proximate to the first side 102 than the port 132, and/or more proximate to the second side 104 than the button 124. The port 132 may be located more proximate to the second side 104 as compared to the button 124 and the apertures 130.

The handle 114 may include a first end 200 and a second end 202. In an embodiment, along the second side 104, the handle 114 may be disconnected. For example, the first end 200 may be separated from the second end 202. The rotatable assembly 120 may be configured to reside within a gap distance 204 disposed between the first end 200 and the second end 202. As will be explained herein, an axle may extend between the first end 200 and the second end 202, and the rotatable assembly 120 may be mounted about the axle for coupling the rotatable assembly 120 to the handle 114. For example, the axle may span the gap distance 204 and couple to the first end 200 and the second end 202 of the handle 114.

The rotatable assembly 120 may include a cross-sectional dimension 206 that is greater than a cross-sectional dimension 208 of the handle 114. For example, along the second side 104, the handle 114 may have the cross-sectional dimension 208. The cross-sectional dimension 206 of the rotatable assembly 120 may be greater than the cross-sectional dimension 208 in order be disposed beyond, extend proud of, etc., the handle 114.

An interior cavity 210 (e.g., void, space, hollow, etc.) may be disposed internal to sides, surfaces, etc., of the handle 114 to permit the user to grasp the handle 114. For example, when the user grasps the handle 114, such as along the first side 102, the third side 106, and/or the fourth side 108, portions of fingers of the user may be disposed within the interior cavity 210. In other words, when the fingers of the user wrap about the handle 114, the interior cavity 210 may provide a space for the fingers of the user. The interior cavity 210 may be sized such that when the user grasps the handle 114, the fingers of the user avoid contacting the rotatable assembly 120.

In an embodiment, the handle 114 may include protrusions 212, such as a first protrusion 212(1) and a second protrusion 212(2). The protrusions 212 may serve as references, datums, etc., for the user. For example, when the user grasps the handle 114 along the third side 106 and/or the fourth side 108, the protrusions 212 may indicate to the user that their fingers are adjacent to the rotatable assembly 120. This may indicate to the user to raise their fingers (e.g., back towards the first side 102) or to avoid moving their fingers further towards the second side 104 to avoid contact with the rotatable assembly 120. However, the interior cavity 210 may be of sufficient size to avoid the fingers of the user contacting the rotatable assembly 120 when the handle 114 is grasped.

In an embodiment, the handle 114 may include a trapezoidal shape (e.g., about the X-Y plane). The handle 114 may arc between the first end 200 and the second end 202. The handle 114 may vary in size along a path disposed between the first end 200 and the second end 202. For example, a portion of the handle 114 along the first side 102 may be narrower than portions of the handle 114 along the third side 106 and/or the fourth side 108. However, the handle 114 may have sweeping contour between the first end 200 and the second end 202. In an embodiment, a cross-sectional shape of the handle 114 may be ovular, circular, square, etc.

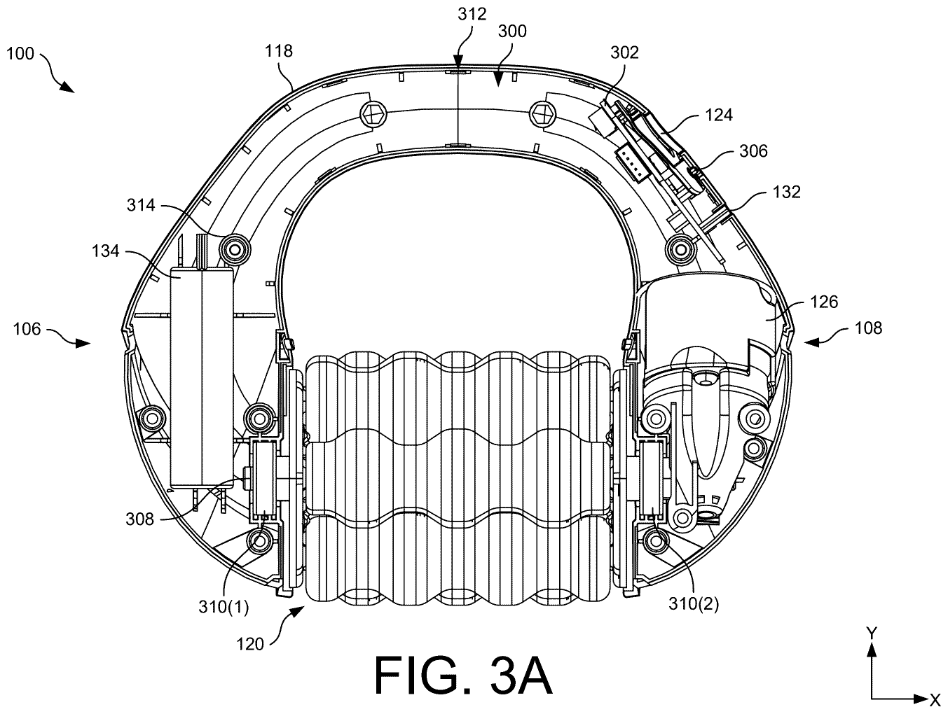

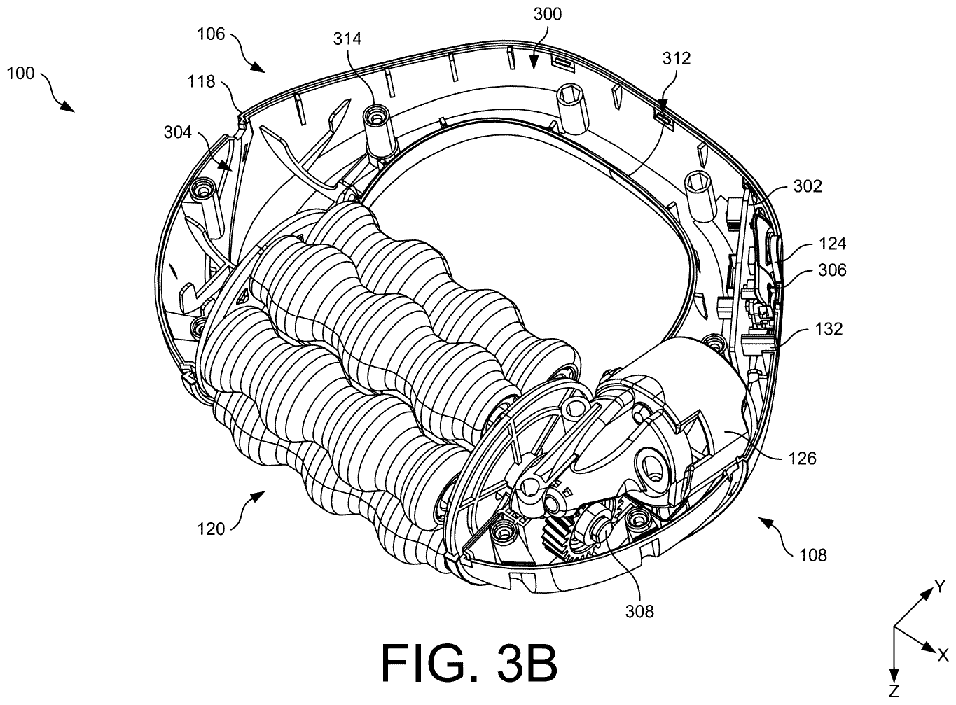

FIGS. 3A and 3B illustrate partial views of the device 100, according to examples of the present disclosure. For example, in FIGS. 3A and 3B, the first housing 116 is shown removed.

The device 100 includes an internal compartment 300 that is formed by the first housing 116 and the second housing 118. The first housing 116 and the second housing 118 may define cavities, voids, pockets, etc., in which components of the device 100 are disposed. The first housing 116 and the second housing 118 may also define receptacles for receiving the components of the device 100. For example, the motor 126, the battery 134, and a PCB 302 may be disposed within the internal compartment 300. The motor 126 and the PCB 302 may be disposed along the fourth side 108, while the battery 134 may be disposed along the third side 106. In an embodiment, the battery 134 may be disposed to a first side of the rotatable assembly 120 (e.g., to the left), while the motor 126 and/or the PCB 302 be disposed to a second side of the rotatable assembly 120 (e.g., to the right).

In FIG. 3B, the battery 134 is shown removed to illustrate a receptacle 304 in which the battery 134 is disposed. The motor 126, the battery 134, and the PCB 302 may be communicatively connected together via wires, cables, flexible printed circuits (FPC), etc., running or disposed throughout the handle 114. Moreover, although the internal compartment 300 is shown including certain components, additional or alternative components are environment.

The button 124 and the port 132 may be connected, or mounted to, the PCB 302. The PCB 302 may couple to the first housing 116 and/or the second housing 118. The lighting element(s) 128 of the device 100, which output light through the apertures 130, may be disposed on the PCB 302. In an embodiment, the device 100 includes a light guide 306 for directing light from the lighting element(s) 128 residing on the PCB 302 through the apertures 130. When assembled, at least a portion of the light guide 306 may be disposed within the apertures 130 formed by the first housing 116 and the second housing 118. As introduced above, in an embodiment that the motor 126 includes three speeds, the light guide 306 may include three corresponding features (e.g., prongs, pins, etc.), where respective features may output light from a corresponding lighting element of the lighting element(s) 128 through the apertures 130. The first housing 116 and the second housing 118 may include various prongs, flanges, mounts, etc., for aligning or otherwise situating the PCB 302 and the light guide 306 within, or to, the first housing 116 and/or the second housing 118. Various processor(s), memory, resistor(s), computing components, etc., may be disposed on the PCB 302 for controlling an operation of the device 100.

The rotatable assembly 120 is disposed about an axle 308. In an embodiment, the axle 308 may couple to the handle 114 via bearings 310, such as a first bearing 310(1) and a second bearing 310(2). For example, the axle 308 may be mounted about the first bearing 310(1) and the second bearing 310(2). As will be explained herein, the first housing 116 and the second housing 118 may include receptacles in which the bearings 310 are disposed, respectively, for seating the bearings 310 within the device 100.

The first housing 116 and the second housing 118 may couple together via fasteners, snap-fits, pressure-fits, etc. For example, the second housing 118 may include attachment mechanism(s) 312 that correspondingly engage with attachment mechanism(s) of the first housing 116. The attachment mechanism(s) 312 may represent pins, tabs, flanges, keys, keyways, etc., that engage with complimentary attachment mechanism(s) on the first housing 116. In addition, the second housing 118 may include posts 314 that receive fasteners disposed through apertures of the first housing 116 for coupling the first housing 116 and the second housing 118 together. The fasteners may be secured (e.g., threaded) into the posts 314. In an embodiment, the first housing 116 and/or the second housing 118 may include alignment mechanisms that align the first housing 116 and the second housing 118 together.

Although certain components are shown and described, other components may be disposed within the internal compartment 300, about the handle 114, within the first housing 116 and/or the second housing 118, etc. For example, proximity sensors may be disposed about the handle, along an interior surface of the second housing 118, for example, for use in determining whether the user is grasping the handle 114. This may increase a safety of the device 100 and restrict the device 100 from being operated when the presence of the user is not sensed. Any number of proximity sensors may be disposed about the handle 114, and the proximity sensors may be disposed about various locations on the handle 114 to sense the user. Moreover, additional or alternative sensors may be used, including capacitive sensors, resistive sensors, optical light sensors, etc.

The proximity sensors may generate the sensor data 144 that indicates whether or not the hand of the user is grasping the handle 114. If the hand is grasping the handle 114, the device 100 may be permitted to operate. However, if the hand is not grasping the handle 114, the device 100 may not be permitted to operate, or may be permitted to operate for a certain threshold of time (e.g., five seconds after being grasped). For example, if the user does not grasp the handle 114 for more than a threshold period of time (e.g., three seconds), the motor 126 may be powered off. The threshold period of time may avoid the user grasping the handle 114 with different hands (e.g., switching between the left hand and the right hand) and inadvertently having the motor 126 power off. In an embodiment, prior to permitting the button 124 to be depressed, the device 100 may first determine whether the user is grasping the handle 114 (e.g., via the sensor data) Alternatively, prior to actuation of the motor 126, the device 100 may first determine whether the user is grasping the handle 114.

The device 100 may also include network interface(s) (e.g., Wi-Fi module, Cellular module, etc.) for communicating with other devices over one or more network(s). Various heat dissipating element(s) may also be disposed within the handle 114.

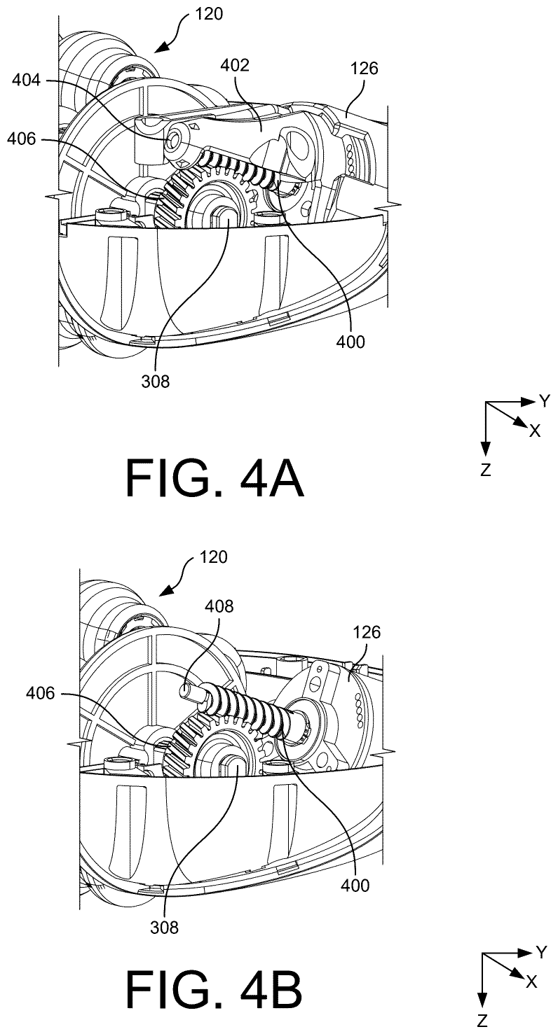

FIGS. 4A and 4B illustrate an engagement between the motor 126 to the rotatable assembly 120, according to examples of the present disclosure. The motor 126 may be coupled to, or include, a gear 400. In an embodiment, the gear 400 may represent a worm gear The gear 400 may be disposed at least partially within a cover 402, for example. The cover 402 may couple to the motor 126 (or a housing of the motor 126). The cover 402 may include an aperture 404 in which an end 408 of the gear 400 is disposed.

The gear 400 engages with a gear 406 that is coupled to or mounted about the axle 308. In an embodiment, the gear 406 may represent a worm wheel or a helical gear. As shown, the gear 400 engages with the gear 406 in order to impart motion to the rotatable assembly 120. The motor 126 may be configured to rotate in one direction (e.g., clockwise) or multiple directions (e.g., clockwise and counterclockwise). In an embodiment, a rotational axis of the rotatable assembly 120 may be orientated orthogonal to a rotational axis of the gear 400 (or the motor 126).

In FIG. 4B, the cover 402 shown removed. As indicated above, the gear 400 may include the end 408 that is disposed within the aperture 404. The positioning of the end 408 within the aperture 404 may maintain an engagement between the gear 400 and the gear 406, orient the gear 406 relative to the gear 400, and so forth.

Although a certain configuration of the motor 126, the gear 400, and/or the gear 406 is shown, other variations are envisioned. For example, more gears other than the gear 400 and/or the gear 406 may be used to impart motion to the rotatable assembly 120. Different gears may also be used. Moreover, although described as imparting motion to the rotatable assembly 120 from one end of the rotatable assembly 120, motion may be imparted on an opposing end and/or both ends.

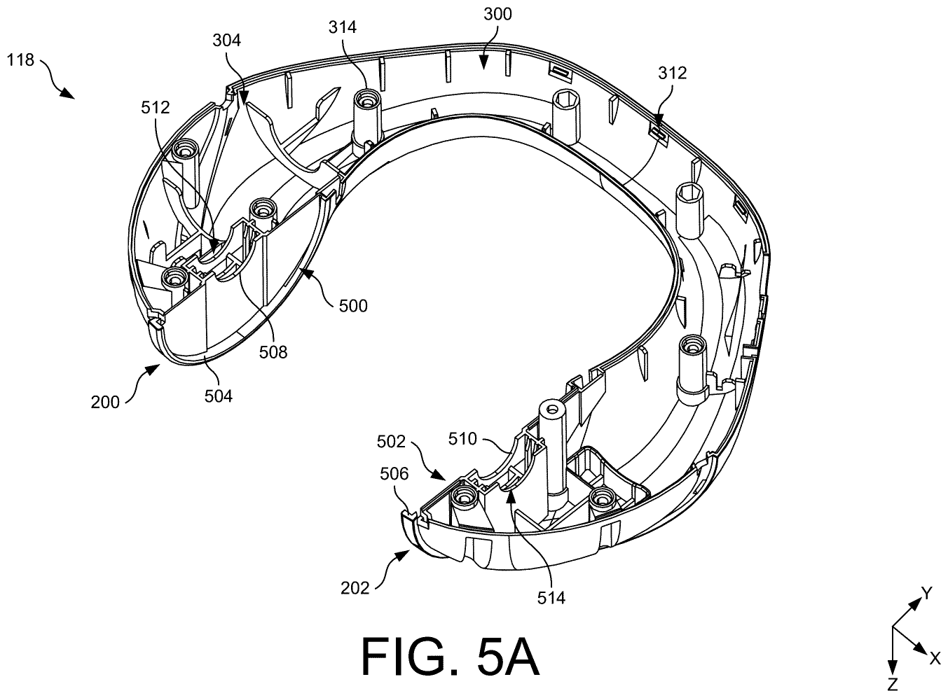

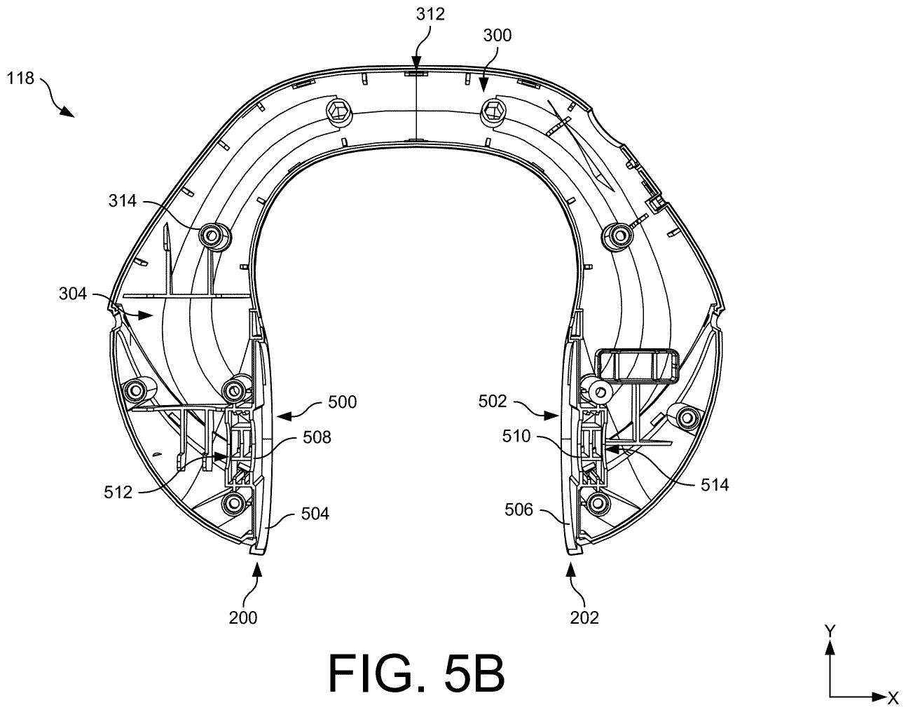

FIGS. 5A and 5B illustrate the second housing 118, according to examples of the present disclosure. The first housing 116 and the second housing 118 may define a first pocket 500 and a second pocket 502 for receiving portions of the rotatable assembly 120. For example, frames of the rotatable assembly 120 may be at least partially disposed within the first pocket 500 and the second pocket 502, respectively. The first pocket 500 may be disposed at the first end 200 of the handle 114 and the second pocket 502 may be disposed at the second end 202 of the handle 114. As shown, the first end 200 and the second end 202 may be spaced apart by the gap distance 204.

The disposition of the rotatable assembly 120 at least partially within the first pocket 500 and the second pocket 502, respectively, may prevent portions of the user (e.g., fingers) or clothing from becoming tangled, pinched, or drawn in during operation of the device 100. For example, a flange 504 at the first end 200 may at least partially form the first pocket 500, and may be annularly disposed around a first frame of the rotatable assembly 120. A flange 506 at the second end 202 may at least partially form the second pocket 502, and may be annularly disposed around a second frame of the rotatable assembly 120.

The first housing 116 and the second housing 118 may define a first opening 508 and a second opening 510 into which ends of the axle 308 are disposed, respectively. A first end of the axle 308 may be disposed through the first opening 508 and a second end of the axle 308 may be disposed through the second opening 510. The first opening 508 and the second opening 510 may be defined by corresponding portions of the first housing 116 and the second housing 118. The first opening 508 may be disposed within the first pocket 500 and the second opening 510 may be disposed within the second pocket 502.

The first housing 116 and the second housing 118 form receptacles for receiving the bearings 310, respectively. For example, a receptacle 512 may receive the first bearing 310(1) and a receptacle 514 may receive the second bearing 310(2). The positioning of the first bearing 310(1) within the receptacle 512 and the second bearing 310(2) within the receptacle 514 may seat, orient, etc., the rotatable assembly 120 relative to the handle 114.

The second housing 118, as introduced above, may also at least partially define the internal compartment 300, the posts 314, the attachment mechanism(s) 312, the receptacle 304 for the battery 134, as well as other tabs, flanges, etc., for receiving, orienting, etc., components of the device 100 within the internal compartment 300 (e.g., the motor 126). The first housing 116 and the second housing 118 may also define openings, apertures, etc., for accommodating the button 124, the port 132, and the light guide 306 (e.g., the apertures 130). The second housing 118 (and/or the first housing 116) may also define orifices for permitting airflow through handle 114 to dissipate heat away from the motor 126, the battery 134, etc.

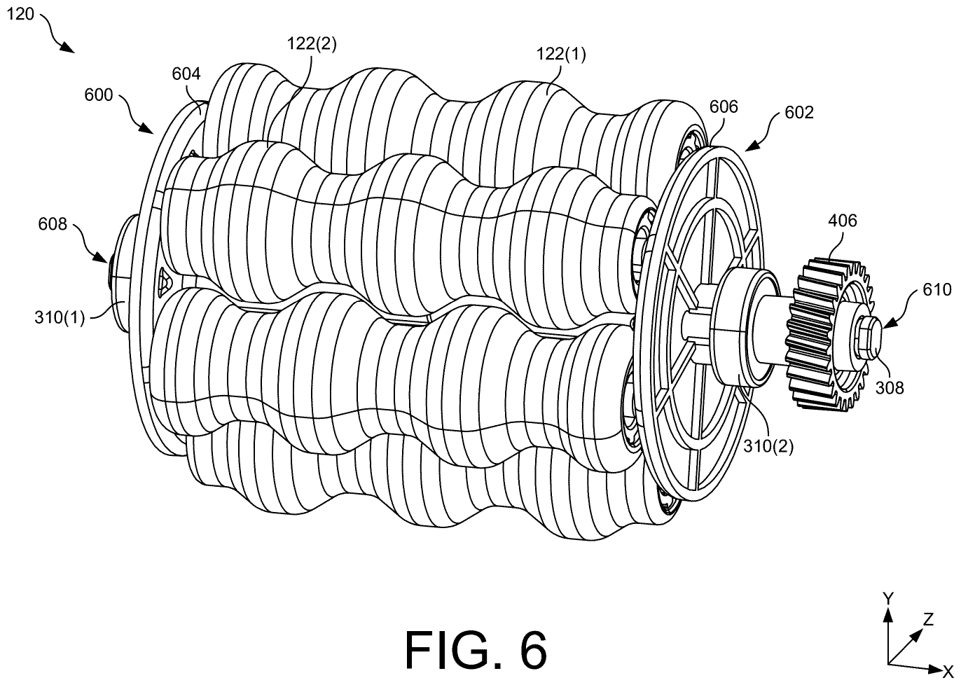

FIG. 6 illustrates the rotatable assembly 120 disposed about the axle 308, according to examples of the present disclosure. In an embodiment, the rotatable assembly 120 may include a first frame 600 and a second frame 602. The first frame 600 and the second frame 602 couple together to form a chassis, body, etc., of the rotatable assembly 120.

The first frame 600 and the second frame 602 may couple to, or be disposed about, the axle 308. As will be explained herein, the first rotatable elements 122(1) and the second rotatable elements 122(2) may be disposed about shafts extending between the first frame 600 and the second frame 602. For example, the shafts may be disposed between a base 604 of the first frame 600 and a base 606 of the second frame 602. Individual rotatable elements 122 may be disposed about the shafts.

As shown, the first bearing 310(1) and the second bearing 310(2) may couple to or be disposed about the axle 308. The first bearing 310(1) may be disposed proximate to a first end 608 of the axle 308 and the second bearing 310(2) may be disposed proximate to a second end 610 of the axle 308, spaced apart from the first end 608 (e.g., in the X-direction). The gear 406 may be disposed at the second end 610, for example. The gear 406 may be disposed between the second bearing 310(2) and the second end 610. The first bearing 310(1) and the second bearing 310(2) are configured to be disposed in the receptacle 512 and the receptacle 514, respectively.

In an embodiment, the gear 406 may be press fit onto the axle 308, fastened to the axle 308, or include keyways, notches, slots, etc., that engage with corresponding features of the axle 308. Alternatively, the gear 406 may be formed directly into (e.g., integrated with) the axle 308.

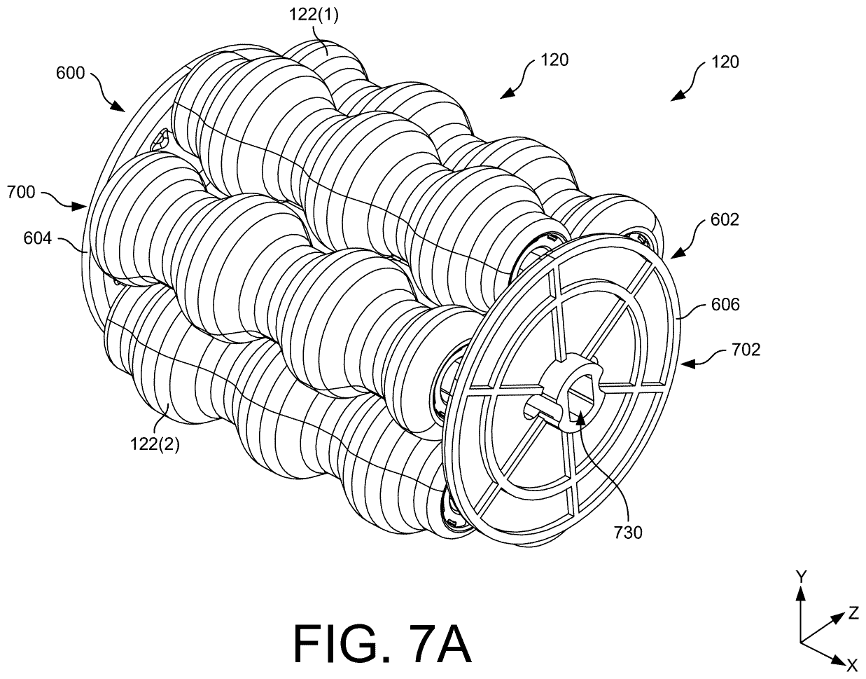

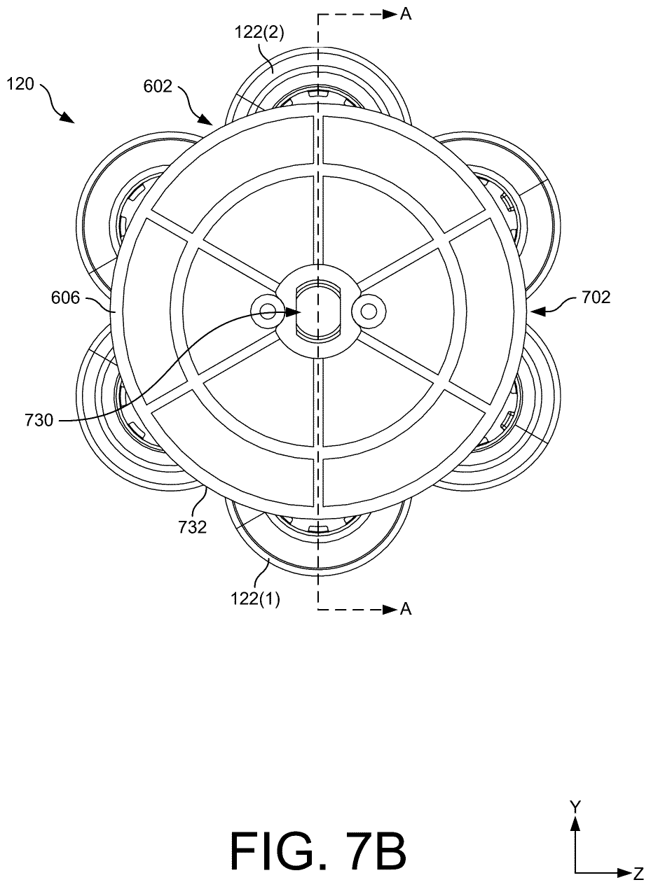

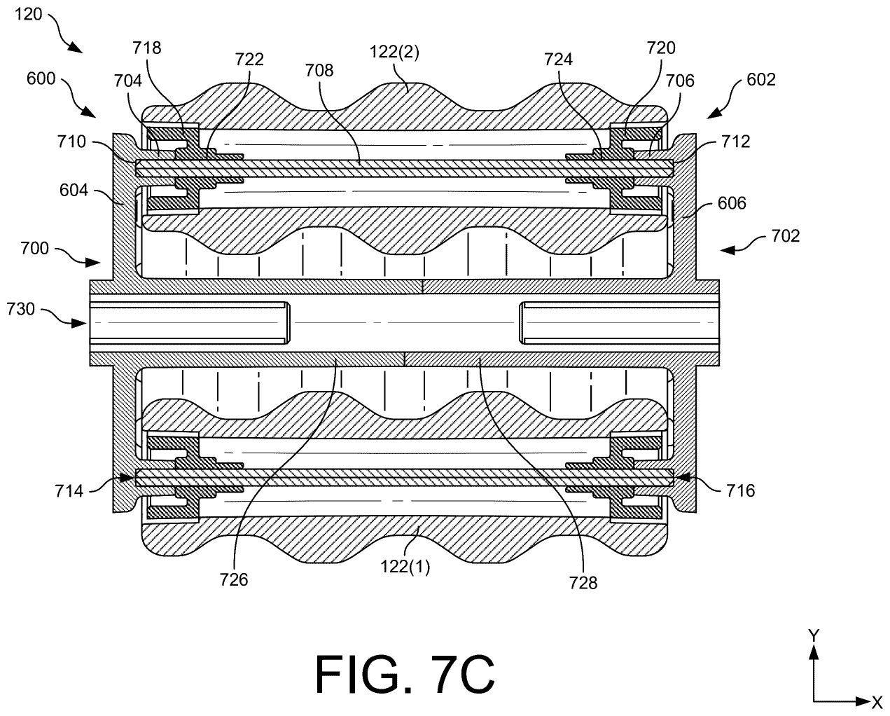

FIGS. 7A-7C illustrate the rotatable assembly 120, according to examples of the present disclosure. FIG. 7A illustrates a perspective view of the rotatable assembly 120, FIG. 7B illustrates an end view of the rotatable assembly 120, and FIG. 7C illustrates a cross-sectional view of the rotatable assembly 120, taken along line A-A of FIG. 7B.

The rotatable assembly 120 may be formed via, or include, the first frame 600, the second frame 602, the first rotatable elements 122(1), and the second rotatable elements 122(2). The base 604 may be configured to be at least partially disposed within the flange 504 and the base 606 may be configured to be at least partially disposed within the flange 506. In an embodiment, the rotatable assembly 120 may include a first end 700 (e.g., adjacent to the base 604) and a second end 702 spaced apart from the first end 700 (e.g., adjacent to the base 606).

The base 604 may define posts 704 and the base 606 may define posts 706. Shafts 708 extend between the base 604 and the base 606 and the first rotatable elements 122(1) and the second rotatable elements 122(2) are disposed about the shafts 708. The posts 704 may define receptacles 710 in which ends of the shafts 708 are disposed, and the posts 706 may define receptacles 712 in which ends of the shafts 708 are disposed, respectively. For example, a first end 714 of the shafts 708 may be disposed within the receptacles 710 and a second end 716 of the shafts 708 may be disposed within the receptacles 712.

Bushings 718 may be disposed adjacent to the posts 704 and bushings 720 may be disposed adjacent to the posts 706. The shafts 708 may be disposed through the bushings 718 and the bushings 720. For example, the bushings 718 may include a channel 722 through which the shafts 708 are disposed and the bushings 720 may include a channel 724 through which the shafts 708 are disposed. The bushings 718 and the bushings 720 may engage with an interior surface of the first rotatable elements 122(1) and the second rotatable elements 122(2). The bushings 718 and the bushings 720 may couple the first rotatable elements 122(1) and the second rotatable elements 122(2) to the shafts 708, respectively.

In an embodiment, the rotatable elements 122 may be rotatable independently of the rotatable assembly 120. For example, the first end 714 of the shafts 708 may rotate within the receptacles 710 and the second end 716 of the shafts 708 may rotate within the receptacles 712. Additionally, or alternatively, the shafts 708 may remain stationary, however, the bushings 718 and the bushings 720 may rotate about the shafts 708. The first rotatable elements 122(1) and the second rotatable elements 122(2) may rotate about their respective axes (e.g., an axis extending through the shafts 708).

The first frame 600 may also include a hub 726 that adjoins to a hub 728 of the second frame 602. The hub 726 and the hub 728 may define a channel 730 in which the axle 308 is disposed. For example, the hub 726 may define a first portion of the channel 730 and the hub 728 may define a second portion of the channel 730. When the first frame 600 and the second frame 602 couple together, the channel 730 may be formed. In an embodiment, the first frame 600 and the second frame 602 may be coupled together via fasteners. The channel 730 may include grooves, slots, etc., that mate with corresponding features of the axle 308. As such, the first frame 600 and the second frame 602 are configured to rotate during actuation of the motor 126 (e.g., with the axle 308) to impart motion to the rotatable assembly 120.

In an embodiment, the rotatable elements 122 may extend beyond a perimeter 732 of the base 604 and the base 606. For example, at least a portion of an exterior surface of the rotatable elements 122 may be disposed beyond the perimeter 732 to engage the user.

In an embodiment, the rotatable assembly 120 may be interchangeable with other rotatable assemblies. For example, each rotatable assembly may have a certain contour or shape of the rotatable elements 122, and interchanging the rotatable assembly 120 may provide different therapeutic relief. As an example, the rotatable assemblies may have different rotatable elements with different contours and shapes. In an embodiment, a size of the rotatable assembly 120 may vary. In an embodiment, quick-disconnect features (e.g., latches, levers, etc.) may be used to interchange the rotatable assembly 120. Additionally, instead of replacing the rotatable assembly 120, the rotatable elements 122 may be additionally or alternatively interchangeable with one another.

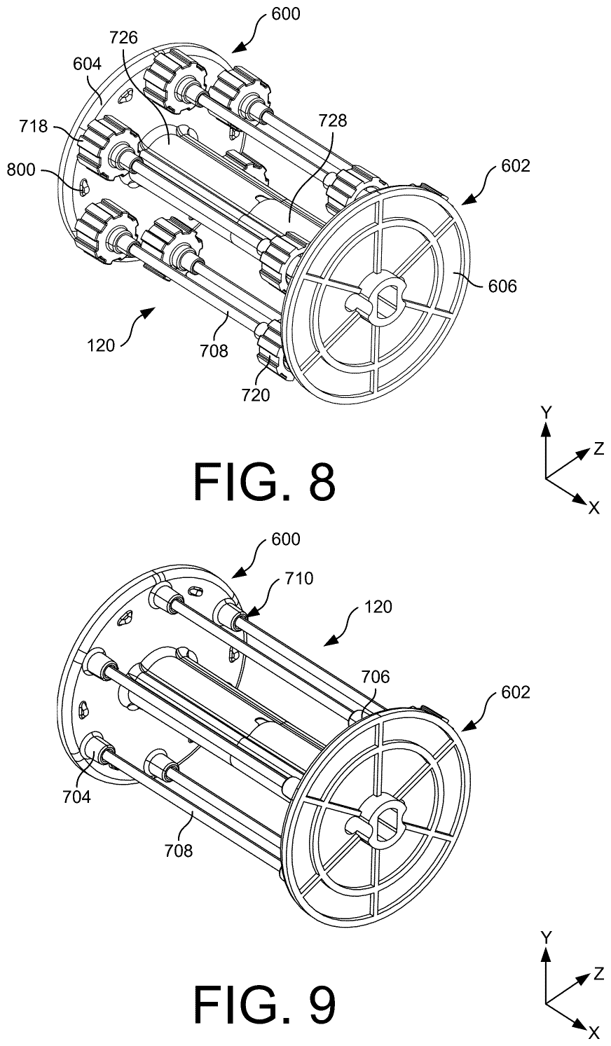

FIG. 8 illustrates a partial view of the rotatable assembly 120, showing the rotatable elements 122 removed, according to examples of the present disclosure.

The first frame 600 may include the base 604 and the second frame 602 may include the base 606 from which second posts 808. The shafts 708 extend between the base 604 and the base 606. As introduced above, the base 604 defines the receptacles 710 and the base 606 defines the receptacles 712. Ends of the shafts 708 are disposed within the receptacles 710 and the receptacles 712, respectively. Additionally, the bushings 718 may be disposed about the receptacles 710 and the bushings 720 may be disposed about the receptacles 712. The ends of the shafts 708 may be disposed through the bushings 718 and the bushings 720, respectively (e.g., via the channel 722 and the channel 724).

The base 604 may include tabs 800. The tabs 800 may be disposed between adjacent posts of the posts 704, or adjacent receptacles of the receptacles 710. As will be explained herein, the tabs 800 may be interposed between ends of the rotatable elements 122, such as between adjacent rotatable elements 122, to prevent portions of the user and/or clothes being drawn in during rotation of the rotatable assembly 120. The base 606 may similarly include tabs.

The first frame 600 may include the hub 726 (e.g., neck, arm, protrusion, etc.) that extends from the base 604 in a direction towards the second frame 602. The hub 726 may engage with the hub 728 of the second frame 602, where the hub 728 may extend in a direction towards the first frame 600. As will be explained herein, the hub 726 may engage with the hub 728 to couple to one another. For example, the hub 726 may include features that interlock with features of the hub 728. In addition, fasteners may be used to couple the first frame 600 and the second frame 602 together.

FIG. 9 illustrates a partial view of the rotatable assembly 120, showing the rotatable elements 122, the bushings 718, and the bushings 720 removed, according to examples of the present disclosure. As introduced above, the ends of the shafts 708 may be disposed within the receptacles 710 and the receptacles 712, respectively. In an embodiment, the bushings 718 may be disposed over the posts 704 that extend from the base 604. Additionally, the bushings 720 may be disposed over the posts 706 that extend from the base 606.

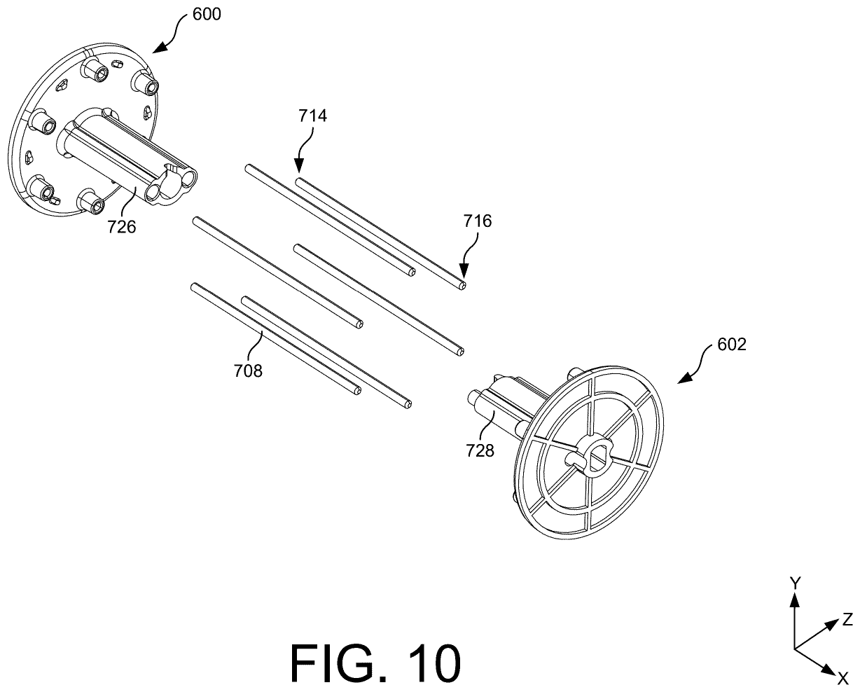

FIG. 10 illustrates a partially exploded view of the rotatable assembly 120, according to examples of the present disclosure.

The first frame 600 includes the hub 726 that couples to the hub 728 of the second frame 602. As will be explained herein, the hub 726 and the hub 728 may include slotted features that mate together in order to couple or align the hub 726 and the hub 728. In addition, the slotted features that mate together may prevent the hub 726 and the hub 728 rotating independently of one another. Fasteners may also couple the hub 726 and the hub 728 together. When coupled together, the first frame 600 and the second frame 602 form the channel 730 through which the axle 308 is disposed.

As introduced above, the shafts 708 may include the first end 714 and the second end 716 spaced apart from the first end 714 (e.g., in the X-direction). The first end 714 may be disposed within the receptacles 710 of the posts 704 and the second end 716 may be disposed within the receptacles 712 of the posts 706. In an embodiment, the shafts 708 may be press fit into the receptacles 710 and/or the receptacles 712, respectively, or may be secured using adhesives, fasteners, etc.

In an embodiment, to assemble the rotatable assembly 120, the first end 714 of the shafts 708 may be disposed in the receptacles 710, respectively. The bushings 718 may be disposed over the shafts 708 before or after insertions of the first end 714 is disposed in the receptacles 710. The rotatable elements 122 may be slide onto the shafts 708. The bushings 720 may then be slid onto the second end 716. Therein, the second frame 602 may couple to the first frame 600. During coupling of the second frame 602 to the first frame 600, the second end 716 of the shafts 708 may be aligned and disposed within the receptacles 712.

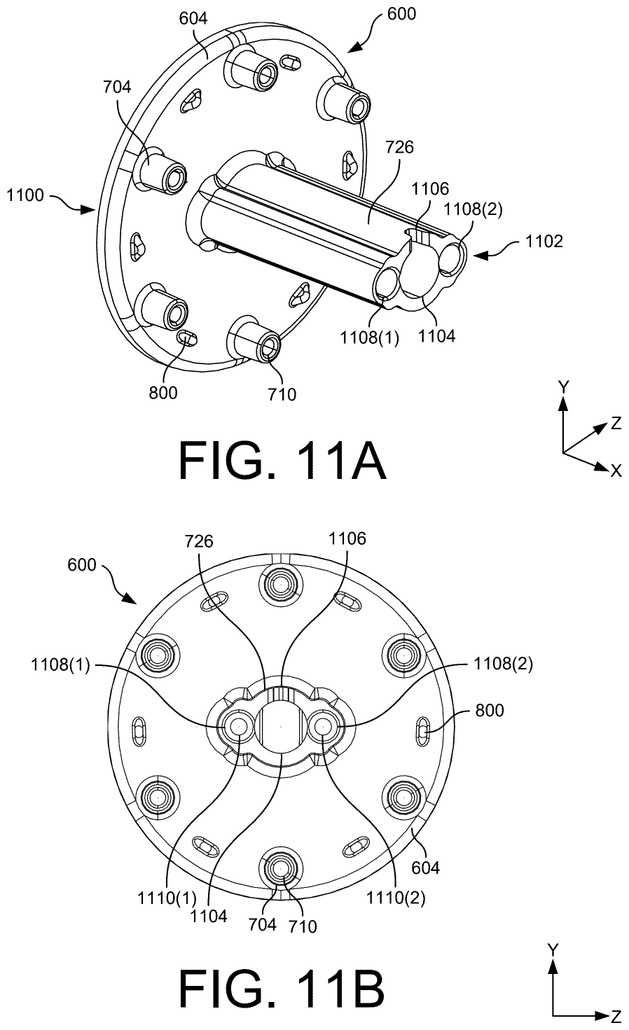

FIGS. 11A and 11B illustrate the first frame 600, according to examples of the present disclosure. The first frame 600, as introduced above, includes the base 604, the posts 704, the tabs 800, and the hub 726. In an embodiment, the first frame 600 includes a first end 1100 and the base 604 may be disposed at the first end 1100. The first frame 600 may include a second end 1102 spaced apart from the first end 1100 (e.g., in the X-direction). The posts 704 may extend from the base 604 in a direction towards the second end 1102. In an embodiment, the first frame 600 may include six of the posts 704, however, more than or less than six of the posts 704 may be included. In such instances, a corresponding number of the rotatable elements 122, the posts 706, and the shafts 708 may be included. The posts 704 define the receptacles 710 for receiving the first end 714 of the shafts 708, respectively.

The hub 726 extends from the base 604 and at least partially defines the channel 730. For example, the hub 726 may define a channel 1104 for receiving at least a portion of the axle 308. The channel 1104 may also be disposed through the base 604. The axle 308 may include a keyed axle, a double D axle, and the like, and the channel 1104 may include corresponding features to engage the axle 308.

The hub 726 may extend from the base 604, in a direction towards the second end 1102. The hub 726 may include a notch 1106 (e.g., indent, channel, etc.) disposed at the second end 1102. A corresponding feature of the hub 728 may engage with the notch 1106, for example, to mate, align, etc., the first frame 600 and the second frame 602. For example, a prong of the hub 728 may be disposed within the notch 1106 to align the first frame 600 and the second frame 602. The engagement between the notch 1106 and the prong may lock, couple, etc., the first frame 600 and the second frame 602 together to prevent the first frame 600 and the second frame 602 rotating independently.

The first frame 600 may also include receptacles 1108, such as a first receptacle 1108(1) and a second receptacle 1108(2) that receive corresponding features of the second frame 602. As shown, the receptacles 1108 may be opposed on either side of the channel 1104. The features of the second frame 602 may include posts, pins, etc., that are disposed within the receptacles 1108, respectively. In an embodiment, the receptacles 1108 include apertures 1110 for receiving fasteners that couple the first frame 600 and the second frame 602 together. For example, a first fastener may be configured to thread into a first aperture 1110(1) and a second fastener may be configured to thread into a second aperture 1110(2). The fasteners may secure the first frame 600 and the second frame 602 after the rotatable elements 122 have be disposed on the shafts 708, and after the shafts 708 may be coupled to the first frame 600 and the second frame 602, respectively.

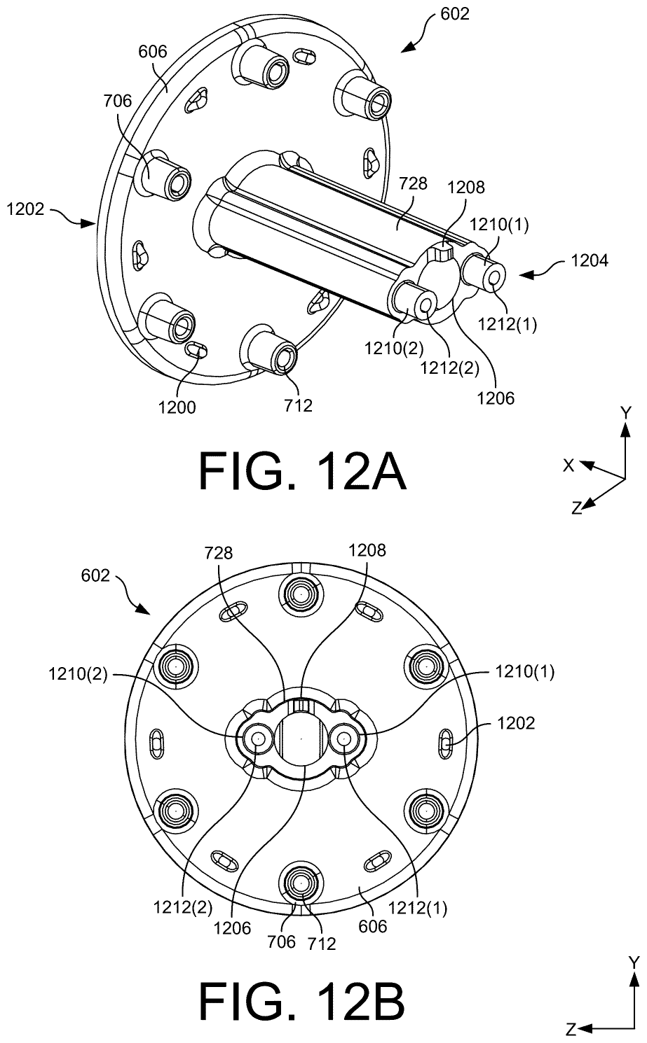

FIGS. 12A and 12B illustrate the second frame 602, according to examples of the present disclosure. The second frame 602, as introduced above, includes the base 606, the posts 706, and the hub 728. The second frame 602 also includes tabs 1200 (similar to the tabs 800) disposed on the base 606. In an embodiment, the second frame 602 includes a first end 1202 and the base 606 may be disposed at the first end 1202. The second frame 602 may include a second end 1204 spaced apart from the first end 1202 (e.g., in the X-direction). The posts 706 may extend from the base 606 in a direction towards the second end 1204. In an embodiment, the second frame 602 may include six of the posts 706 to engage with the six of the posts 704. The posts 704 define the receptacles 712 for receiving the second end 716 of the shafts 708, respectively.

The hub 728 extends from the base 606 and at least partially defines the channel 730. For example, the hub 728 may define a channel 1206 for receiving at least a portion of the axle 308. The channel 1206 may also be disposed through the base 606. The axle 308 may include a keyed axle, a double D axle, and the like, and the channel 1206 may include corresponding features to engage the axle 308.

The hub 728 may extend from the base 606, in a direction towards the second end 1204. The hub 728 may include a prong 1208 (e.g., protrusion, nose, etc.) disposed at the second end 1204. The prong 1208 may engage with the notch 1106, for example, to mate, align, etc., the first frame 600 and the second frame 602. For example, the prong 1208 may be disposed at the second end 1204 to engage with the notch 1106 to align the first frame 600 and the second frame 602. The engagement between the notch 1106 and the prong 1208 may lock, couple, etc., the first frame 600 and the second frame 602.

The second frame 602 may also include posts 1210 (e.g., pillars, prongs, etc.), such as a first post 1210(1) and a second post 1210(2) that are configured to be disposed in the receptacles 1108, respectively. For example, the first post 1210(1) may be disposed in the first receptacle 1108(1) and the second post 1210(2) may be disposed in the second receptacle 1108(2). As shown, the posts 1210 may be disposed on either side of the channel 1206.

In an embodiment, the posts 1210 include passages for receiving fasteners that couple the first frame 600 and the second frame 602 together. For example, a first fastener may be configured to be disposed through a first passage 1212(1) in the first post 1210(1) and into the first aperture 1110(1). A second fastener may be configured to be disposed through a second passage 1212(2) in the second post 1210(2) and into the second aperture 1110(2).

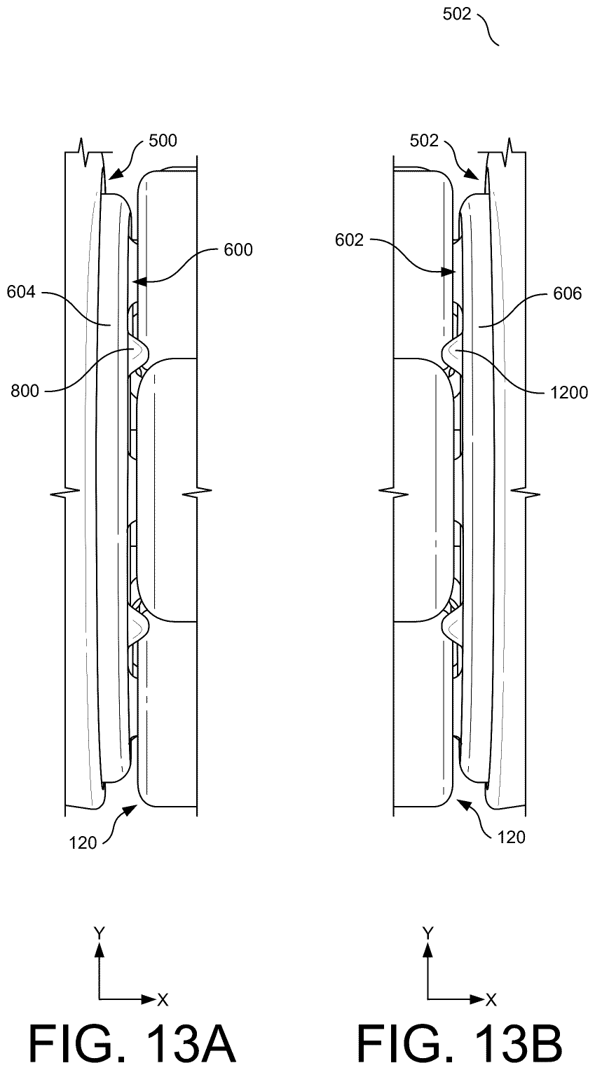

FIGS. 13A and 13B illustrate the first frame 600 and the second frame 602 being disposed within portions of the handle 114, according to examples of the present disclosure. The first frame 600 may be disposed within the first pocket 500 formed at least in part by the first housing 116 and the second housing 118. The second frame 602 may be disposed within the second pocket 502 formed at least in part by the first housing 116 and the second housing 118. The first frame 600 and the second frame 602 may be configured to rotate within the first pocket 500 and the second pocket 502, respectively. However, the positioning of the first frame 600 and the second frame 602 at least partially within the first pocket 500 and the second pocket 502, respectively, may prevent portions of the user (e.g., fingers) or clothing from becoming tangled, pinched, or drawn in during operation of the device 100.

As also shown, the tabs 800 and the tabs 1200 may be disposed in between the rotatable elements 122. The tabs 800 and the tabs 1200 may prevent portions of the user (e.g., fingers) or clothing from becoming tangled, pinched, or drawn in during operation of the device 100.

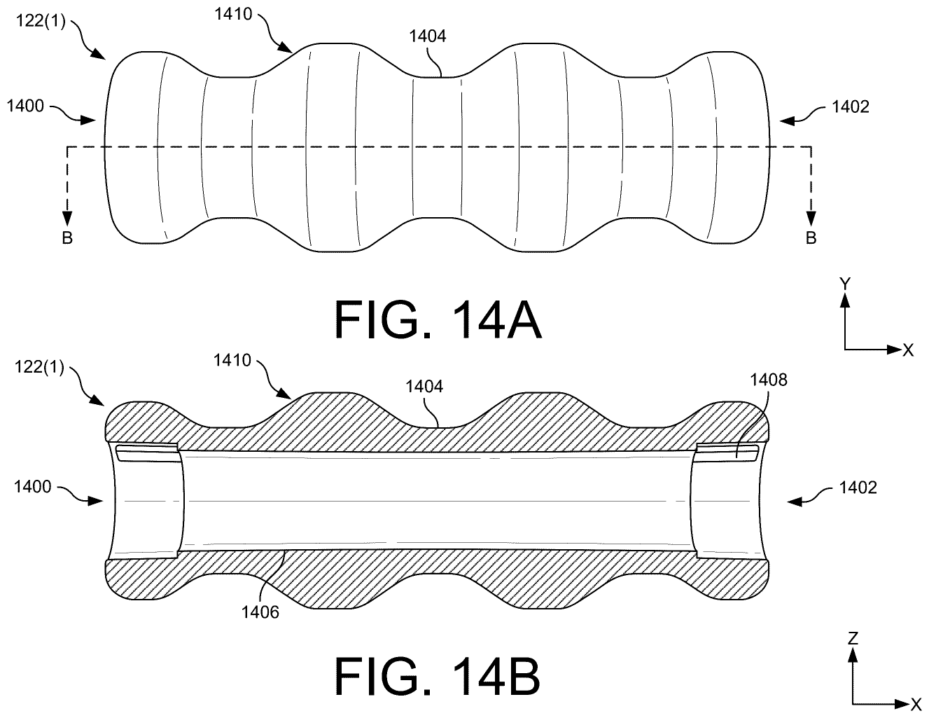

FIGS. 14A and 14B illustrate the first rotatable element 122(1), according to examples of the present disclosure. FIG. 14A illustrates a side view of the first rotatable element 122(1) and FIG. 14B illustrates a cross-sectional view of the first rotatable element 122(1) taken along line B-B of FIG. 14A.

The first rotatable element 122(1) may include a first end 1400 and a second end 1402 spaced apart from the first end 1400 (e.g., in the X-direction). The first rotatable element 122(1) may include an exterior surface 1404 and a channel 1406 that extends through the first rotatable element 122(1), between the first end 1400 and the second end 1402. The shafts 708 may be disposed through the channel 1406. In addition, the bushings 718 and the bushings 720 may be disposed within the channel 1406. For example, the bushings 718 may be disposed within the channel 1406, proximate to the first end 1400 and the bushings 720 may be disposed within the channel 1406 proximate to the second end 1402.

In an embodiment, the channel 1406 may include different cross-sectional dimensions. For example, proximate to the first end 1400 and the second end 1402, the channel 1406 may include a cross-sectional dimension that is larger than a cross-sectional dimension of a central portion of the channel 1406, for example. The larger cross-sectional dimension may accommodate the bushings 718 and the bushings 720. Moreover, in an embodiment, at the first end 1400 and the second end 1402, the first rotatable element 122(1) may include ribs 1408 disposed within the channel 1406. The ribs 4108 may engage the bushings 718 and the bushings 720 to secure the first rotatable element 122(1) to the shafts 708.

As shown, the exterior surface 1404 may undulate in a lengthwise direction of the first rotatable element 122(1), between the first end 1400 and the second end 1402. In an embodiment, peaks of the exterior surface 1404 correspond to myofascial features 1410 that provide myofascial relief to a user. For example, the myofascial features 1410 may be bulbous shaped, triangular shaped, circular shaped, etc. knobs, projections, etc., for providing myofascial relief. In an embodiment, the first rotatable element 122(1) may include four of the myofascial features 1410, however, more than or less than four of the myofascial features 1410 may be included. In an embodiment, the myofascial features 1410 may be differently shaped and/or sized. For example, peaks of the myofascial features 1410 may extend different distances from the exterior surface 1404.

Although the first rotatable element 122(1) is shown as being a single continuous piece of material, other variations are envisioned. For example, the first rotatable element 122(1) may include separate and distinct pieces of material that are disposed along the shafts 708. In such embodiments, these different pieces may be slid onto the shafts 708, for example.

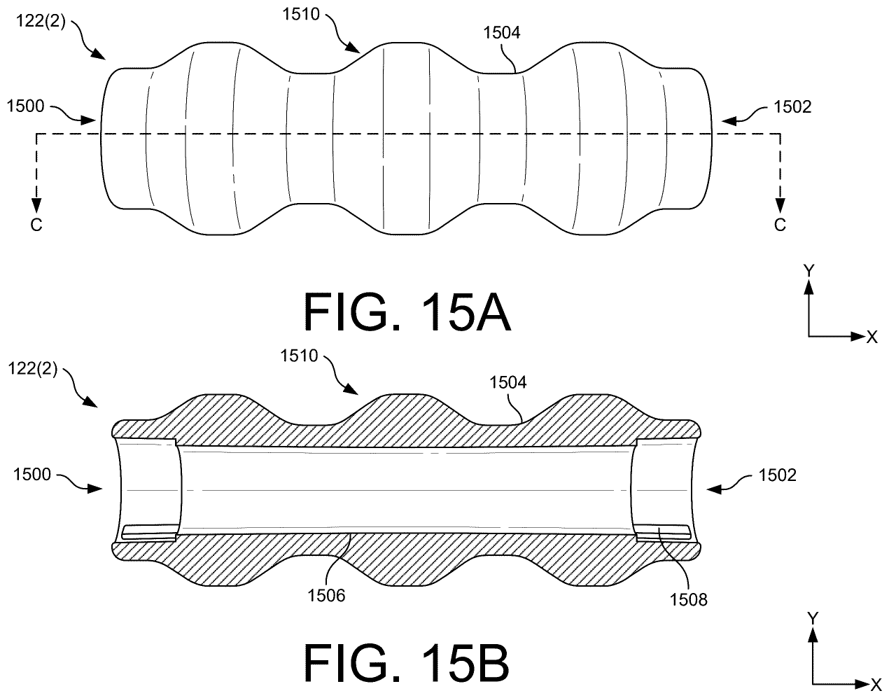

FIGS. 15A and 15B illustrate the second rotatable element 122(2), according to examples of the present disclosure. FIG. 15A illustrates a side view of the second rotatable element 122(2) and FIG. 15B illustrates a cross-sectional view of the second rotatable element 122(2) taken along line C-C of FIG. 15A.

The second rotatable element 122(2) may include a first end 1500 and a second end 1502 spaced apart from the first end 1500 (e.g., in the X-direction). The second rotatable element 122(2) may include an exterior surface 1504 and a channel 1506 that extends through the second rotatable element 122(2), between the first end 1500 and the second end 1502. The shafts 708 may be disposed through the channel 1506. In addition, the bushings 718 and the bushings 720 may be disposed within the channel 1506. For example, the bushings 718 may be disposed within the channel 1506, proximate to the first end 1500 and the bushings 720 may be disposed within the channel 1506 proximate to the second end 1502.

In an embodiment, the channel 1506 may include different cross-sectional dimensions. For example, proximate to the first end 1500 and the second end 1502, the channel 1506 may include a cross-sectional dimension that is larger than a cross-sectional dimension of a central portion of the channel 1506, for example. The larger cross-sectional dimension may accommodate the bushings 718 and the bushings 720. Moreover, in an embodiment, at the first end 1500 and the second end 1502, the second rotatable element 122(2) may include ribs 1508 disposed within the channel 1506. The ribs 1508 may engage the bushings 718 and the bushings 720 to secure the second rotatable element 122(2) to the shafts 708.

The exterior surface 1504 may undulate in a lengthwise direction of the second rotatable element 122(2), between the first end 1500 and the second end 1502. In an embodiment, peaks of the exterior surface 1504 correspond to myofascial features 1510 that provide myofascial relief to the user. For example, the myofascial features 1510 may be bulbous shaped, triangular shaped, circular shaped, etc., knobs, projections, etc., to provide myofascial relief. In an embodiment, the second rotatable element 122(2) may include three of the myofascial features 1510, however, more than or less than three of the myofascial features 1510 may be included.

In an embodiment, the myofascial features 1510 may be different or similar to the myofascial features 1410. For example, the myofascial features 1410 and the myofascial features 1510 may be configured to interlock, or may be interwoven. Peaks of the myofascial features 1510 may be disposed within valleys of the myofascial features 1410, and peaks of the myofascial features 1410 may be disposed within valleys of the myofascial features 1510.

Although the second rotatable element 122(2) is shown as being a single continuous piece of material, other variations are envisioned. For example, the second rotatable element 122(2) may include separate and distinct pieces of material that are disposed along the shafts 708. In such embodiments, these different pieces may be slid onto the shafts 708, for example.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A myofascial device comprising:
a handle including a first end and a second end;
a motor at least partially disposed within the handle;
a battery at least partially disposed within the handle; and
a rotatable assembly disposed between the first end and the second end, the rotatable assembly being configured to rotate during operation of the motor, the rotatable assembly including:
a first frame,
a second frame,
shafts disposed between the first frame and the second frame,
first rotatable elements disposed about a first portion of the shafts, and
second rotatable elements disposed about a second portion of the shafts.

2. The myofascial device of claim 1, further comprising a button configured to control the operation of the motor.

3. The myofascial device of claim 1, further comprising one or more lighting elements configured to illuminate according to a setting of the motor.

4. The myofascial device of claim 1, wherein:
the first frame includes posts having a receptacle;
the second frame includes posts having a receptacle;
a first end of the shafts is disposed within the receptacle of the posts of the first frame; and
a second end of the shafts is disposed within the receptacle of the posts of the second frame.

5. The myofascial device of claim 1, wherein:
the first rotatable elements include first myofascial features; and
the second rotatable elements include second myofascial features that are different than the first myofascial features.

6. The myofascial device of claim 1, further comprising an axle, wherein:
the rotatable assembly is disposed about the axle;
the motor includes a first gear; and
the first gear engages with a second gear coupled to the axle.

7. A device comprising:
a handle including:
a first end, and
a second end;
a rotatable assembly at least partially disposed between the first end and the second end, the rotatable assembly including:
a first frame having:
a base,
a hub extending from the base of the first frame, and
receptacles,
a second frame having:
a base,
a hub extending from the base of the second frame and coupled to
the hub of the first frame, and
receptacles,
shafts disposed between the base of the first frame and the base of the second frame, wherein individual shafts are disposed within individual receptacles of the first frame and individual receptacles of the second frame, and
rotatable elements disposed about the individual shafts of the shafts; and
a motor operably coupled to the rotatable assembly to impart motion to the rotatable assembly.

8. The device of claim 7, further comprising one or more lighting elements configured to illuminate based at least in part on a speed of the motor.

9. The device of claim 8, further comprising a button configured to control the speed of the motor.

10. The device of claim 9, further comprising a port, wherein the one or more lighting elements are interposed between the button and the port.

11. The device of claim 7, wherein:
the rotatable elements include first rotatable elements and second rotatable elements;
the first rotatable elements are disposed about a first portion of the shafts; and
the second rotatable elements are disposed about a second portion of the shafts.

12. The device of claim 7, wherein the handle defines an interior cavity that provides an area for a user to grasp the handle.

13. The device of claim 7, wherein:
the base of the first frame includes tabs;
the base of the second frame includes tabs;
individual tabs of the tabs of the first frame are disposed between adjacent rotatable elements; and
individual tabs of the tabs of the second frame are disposed between adjacent rotatable elements.

14. The device of claim 7, further comprising first bushings and second bushings, wherein:
individual first bushings of the first bushings are disposed at least partially within the individual rotatable elements and about the individual shafts; and
individual second bushings of the second bushings are disposed at least partially within the individual rotatable elements and about the individual shafts.

15. A device comprising:
a handle;
a motor disposed within the handle; and
a rotatable assembly coupled to the handle, the motor being configured to impart movement to the rotatable assembly, the rotatable assembly including:
a first frame having:
a base,
receptacles, and
a hub,
a second frame having:
a base,
receptacles, and
a hub coupled to the hub of the first frame,
shafts, individual shafts of the shafts having a first end and a second end, wherein the first end of the individual shafts is disposed within individual receptacles of the first frame, and the second end of the individual shafts is disposed within individual receptacles of the second frame, and
rotatable elements, individual rotatable elements of the rotatable elements being disposed about the individual shafts.

16. The device of claim 15, wherein:
the base of the first frame includes posts that have the receptacles of the first frame; and
the base of the second frame includes posts that have the receptacles of the second frame.

17. The device of claim 15, wherein:
the handle includes a first end and a second end; and
the rotatable assembly is disposed between the first end of the handle and the second end of the handle.

18. The device of claim 17, wherein:
the first end of the handle includes a pocket;
the second end of the handle includes a pocket;
the base of the first frame is at least partially disposed within the pocket at the first end; and
the base of the second frame is at least partially disposed within the pocket at the second end.

19. The device of claim 15, further comprising at least one of:
a button to control a speed of the motor; or
one or more lighting elements configured to illuminate based at least in part on the speed of the motor.

20. The device of claim 15, wherein:
the rotatable elements include first rotatable elements and second rotatable elements;
the first rotatable elements are disposed about a first portion of the shafts; and
the second rotatable elements are disposed about a second portion of the shafts.
